(19) United States
(12) Patent Application Publication
(10) Pub. No.: US 2005/0171942 A1
(43) Pub. Date: Aug. 4, 2005

(54) Information processing apparatus, data search method and data search program that can reduce processing time for obtaining data

(76) Inventors: Yohko Ohtani, Tokyo (JP); Junichi Minato, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/023,481

(22) Filed: Dec. 29, 2004

(30) Foreign Application Priority Data
Jan. 8, 2004 (JP) 2004-003120

(51) Int. Cl. G06F 7/00

(52) U.S. Cl. 707/3

(57) ABSTRACT

An information processing apparatus is capable of searching an information storing server located outside for data formed with one or more attributes. Data types of the attributes can be set. When setting an attribute to be obtained from the information storing server as an obtaining attribute, a corresponding one of the data types of each of the attributes can be presented to a user.

### BACKGROUND OF THE INVENTION

1. Field of the Invention

The present invention generally relates to information processing apparatuses, data search methods and data search programs, and more particularly, to an information processing apparatus, a data search method and a data search program that search an information storing server located outside for data formed with one or more attributes.

2. Description of the Related Art

Recently, in a system where one or more information processing apparatuses (hereinafter referred to as “clients” or “client”) and an information storing server are connected to each other via a network, the clients often obtain data formed with one or more attributes and stored in the information storing server. For example, Japanese Laid-Open Patent Application No. 2003-108558 discloses that, in a data search system where client terminals and a data server are connected to each other via a network, the clients search the data server for data.

The information storing server is configured to comply with, for example, LDAP (Lightweight Directory Access Protocol). Hereinafter, a server complying with the LDAP is referred to as a LDAP server.

Data managed by the LDAP server include text data and binary data. The data managed by the LDAP server are formed with one or more attributes. The attributes forming the data include those defined by RFC (Request For Comments) and those originally defined in the LDAP server. In addition, the data size of data managed by LDAP servers varies from server to server.

In the case of a LDAP server implementing the specification of LDAP version 3 defined by RFC 2251, a client can obtain a list of descriptions of attributes (hereinafter referred to as “schema”) managed by the LDAP server.

An image processing apparatus, which is an example of a client, includes in a single housing functions of various apparatuses such as a printing apparatus, a copying apparatus, a facsimile apparatus, and a scanner. An image processing apparatus is provided with a display part, a printing part, and an imaging part in a single housing. In addition, an image processing apparatus also has installed four kinds of software corresponding to a printing apparatus, a copying apparatus, a facsimile apparatus, and a scanner. It is possible to cause such an image processing apparatus to operate as a printing apparatus, a copying apparatus, a facsimile apparatus, or a scanner by switching among the four kinds of software. For example, Japanese Laid-Open Patent Application No. 2002-84383 discloses an image processing apparatus as an example of a client.

However, depending on the version or implementation of a LDAP server, a client cannot always obtain a list of schemas of the LDAP server. Additionally, even if the list of schemas is obtained from the LDAP server, in some cases, attributes and/or data size of data are not correctly defined in the list of schemas. In such cases, it is difficult or impossible for the client to estimate the data size or the processing time required for obtaining the data from the LDAP server.

Accordingly, there is a problem in that, when a client searches a LDAP server for data, it takes a long processing time until the data obtained from the LDAP server as the result of searching are processed and displayed.

Further, there is also a problem in that, in the case where the obtained data are binary data, the client uselessly performs an encoding process, which is to be performed on text data. Methods for estimating the data type (e.g., binary data and text data) of data obtained from a LDAP server include, for example, a method for estimating the data type by obtaining a sub-schema entry defined in the RFC, and a method for estimating the data type in accordance with a standard schema defined in the RFC.

However, even if a standard schema is defined in the RFC, a client cannot always obtain a sub-schema entry as mentioned above. There is a problem in that, with the method for estimating the data type by obtaining the sub-schema entry, it is impossible to estimate the data type unless the sub-schema entry is obtained.

Additionally, even if a standard schema is defined in the RFC, a LDAP server is not necessarily implemented in conformity with the regulations of the RFC. In addition, a LDAP server can create its own attributes. There is a problem in that the method for estimating the data type in accordance with the standard schema defined in the RFC cannot estimate the data type in the cases where the LDAP server is not implemented in conformity with the regulations of the RFC and where the LDAP server creates its own attributes.

### SUMMARY OF THE INVENTION

A general object of the present invention is to provide an improved and useful information processing apparatus, data search method, and data search program in which one or more of the above-mentioned problems are eliminated.

Another and more specific object of the present invention is to provide an information processing apparatus, a data search method, and a data search program that can readily reduce processing time when obtaining, from an information storing server, data formed with one or more attributes.

In order to achieve the above-mentioned objects, according to one aspect of the present invention, there is provided an information processing apparatus capable of searching an information storing server located outside for data formed with one or more attributes,
wherein data types of the attributes can be set and, when setting an attribute to be obtained from the information storing server as an obtaining attribute, a corresponding one of the data types of each of the attributes can be presented to a user.

Additionally, according to another aspect of the present invention, there is provided a data search method for an information processing apparatus capable of searching an information storing server located outside for data formed with one or more attributes, said data search method including the steps of:
presenting data types of the attributes to a user; and
causing the user to set one or more of the attributes to be obtained from the information storing server as an obtaining attribute.

Additionally, according to another aspect of the present invention, there is provided a data search program for causing a computer to search an information storing server located outside for data formed with one or more attributes, said data search program including the instructions of:
presenting data types of the attributes to a user; and
causing the user to set one or more of the attributes to be obtained from the information storing server as an obtaining attribute.

According to the present invention, since data formed with one or more attributes are obtained from an information storing server, when setting one of the attributes to be obtained from the information storing server as an obtaining attribute, the data type of each attribute is presented to a user. That is, it is possible to set the data types of an attribute to be obtained from the information storing server.

A user can set an attribute to be obtained from the information storing server while confirming the data type of each attribute. For example, by setting an attribute having a data type (e.g., text data) that generally requires a short processing time as an obtaining attribute, it is possible to reduce processing time required for obtaining data from the information storing server. In other words, by setting an attribute having a data type (e.g., binary data) that generally requires a long processing time as an attribute not to be obtained from the information storing server, it is possible to reduce processing time required for obtaining data from the information storing server.

According to the present invention, it is possible to provide an information processing apparatus, a data search method, and a data search program that can readily reduce processing time for obtaining, from an information storing server, data formed with one or more attributes.

Other objects, features and advantages of the present invention will become more apparent from the following detailed description when read in conjunction with the following drawings.

### BRIEF DESCRIPTION OF THE DRAWINGS

FIG. 1 is a block diagram for explaining the software configuration of a multi-functional apparatus according to one embodiment of the present invention;

FIG. 2 is a block diagram for explaining the hardware configuration of a multi-functional apparatus according to one embodiment of the present invention;

FIG. 3 is a diagram for explaining an obtaining request, an addition request, a modification request, and a deletion request for LDAP server information;

FIG. 4 is a block diagram for explaining an exemplary software configuration of a UCS realizing a search function;

FIG. 5 is a sequence diagram of an example of the LDAP search;

FIG. 6 is a data structure diagram of a search result;

FIG. 7 is a data structure diagram of exemplary LDAP user information;

FIG. 8 is a flowchart for explaining a process of converting a search result to the data structure of an entry for the multi-functional apparatus;

FIG. 9 is a diagram showing an exemplary image of an attribute setting screen for setting an attribute;

FIG. 10 is a diagram for explaining LDAP user information to which data types are added;

FIG. 11 is a diagram showing exemplary images of an obtaining attribute setting screen for setting an obtaining attribute;

FIG. 12 is a diagram showing another exemplary image of the attribute setting screen for setting an attribute;

FIG. 13 is a sequence diagram of an exemplary process of obtaining the data type of a set attribute;

FIG. 14 is a diagram showing other images of the attribute setting screen for setting an attribute;

FIG. 15 is a sequence diagram of an exemplary process of causing a user to determine the data type of a set attribute;

FIG. 16 is a sequence diagram of an exemplary process of obtaining the data type of a set attribute with a plurality of methods;

FIG. 17 is a sequence diagram of an example of the LDAP search according to the present invention;

FIG. 18 is a data structure diagram for explaining the difference between a search result obtained first and a search result obtained later;

FIG. 19 is a sequence diagram of an example of the LDAP search according to the present invention;

FIG. 20 is a diagram showing exemplary images of an obtaining order setting screen for setting an obtaining order of attributes;

FIG. 21 is a diagram showing another exemplary image of the obtaining order setting screen for setting an obtaining order of attributes;

FIG. 22 is a diagram showing exemplary images of a display layout setting screen;

FIG. 23 is a sequence diagram of an exemplary process of modifying the display layout of a LDAP search result screen;

FIG. 24 is a diagram for explaining a process of associating an attribute with an item of the multi-functional apparatus corresponding to the attribute and with display layout information for displaying the attribute;

FIG. 25 is a sequence diagram of an example of the LDAP search;

FIG. 26 is a diagram for explaining LDAP user information to which the display layout information is added;

FIG. 27 is a diagram showing an exemplary image of a LDAP search result detail screen;

FIG. 28 is a flowchart for explaining a process of modifying the display layout of the LDAP search result screen in accordance with an item input as a search condition;

FIG. 29 is a diagram showing an exemplary image of a table for recording the specified number of times of searching for each attribute;

FIG. 30 is a diagram showing exemplary candidate attributes for each display layout item;

FIG. 31 is a diagram of an exemplary image of a display layout setting screen;

FIG. 32 is a diagram of another exemplary image of the display layout setting screen; and

FIG. 33 is a sequence diagram of another example of the LDAP search.

### DETAILED DESCRIPTION OF THE PREFERRED EMBODIMENTS

A description is given below of a preferred embodiment of the present invention with reference to the drawings. In this embodiment, a description is given of an information processing apparatus as an example of a client. It should be noted that the information processing apparatus described in this embodiment is referred to as a multi-functional apparatus since the information processing apparatus includes, in a single housing, functions of various apparatuses such as a printing apparatus, a copying apparatus, a facsimile apparatus, and a scanner.

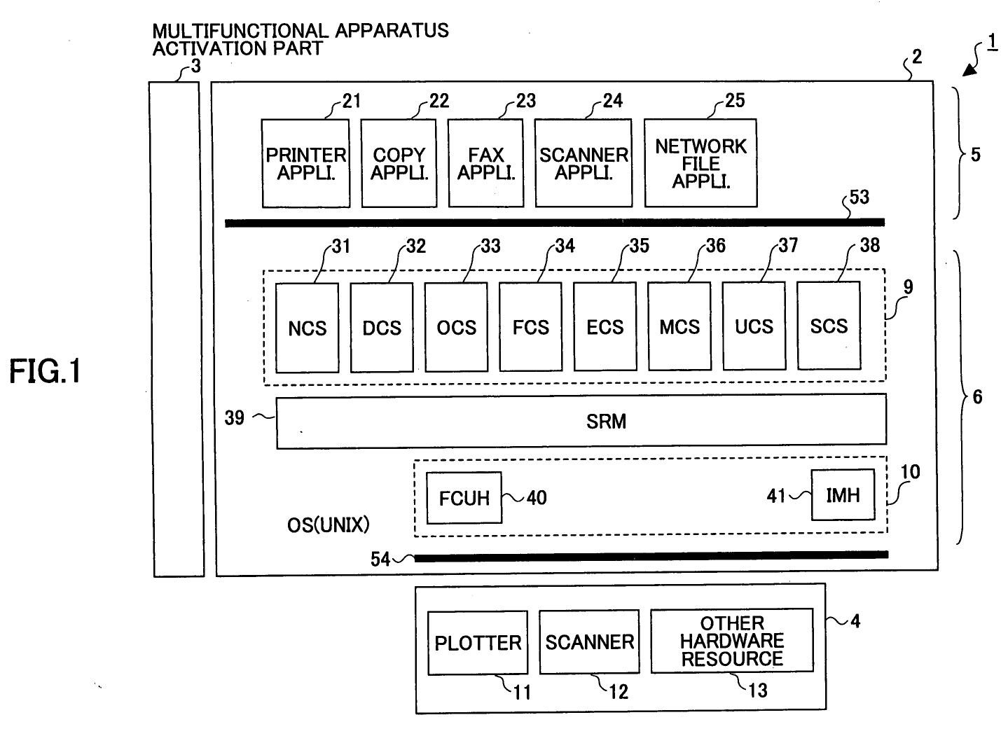

FIG. 1 is a block diagram of a software configuration of a multi-functional apparatus 1 according to one embodiment of the present invention. The multi-functional apparatus 1 includes a group of software 2, a multi-functional apparatus activation part 3, and hardware resources 4.

The hardware resources 4 include a plotter 11, a scanner 12, and other hardware resources 13 such as a facsimile. The group of software 2 includes an application layer 5 and a platform 6, which are activated on an operation system (hereinafter referred to as “OS”) such as UNIX®.

The application layer 5 includes programs that perform processes peculiar to user services relating to image formation such as printing, copying, faxing, and scanning. The application layer of FIG. 1 includes a printer application 21, a copy application 22, a FAX application 23, a scanner application 24, and a network file application 25. The network file application 25 is an application for network files, and manages data communications with network apparatuses coupled to the multi-functional apparatus 1 via a network.

The platform 6 includes a control service layer 9, a system resource manager (hereinafter referred to as “SRM”) 39, and a handler layer 10. The control service layer 9 interprets a process request from the application layer 5 and issues an obtaining request for the hardware resources 4. The SRM 39 manages one or more of the hardware resources 4 and mediates the obtaining request from the control service layer 9. The handler layer 10 manages the hardware resources 4 in accordance with the obtaining request from the SRM 39.

The control service layer 9 includes one or more service modules such as a NCS (network control service) 31, a DCS (delivery control service) 32, an OCS (operational panel control service) 33, a FCS (FAX control service) 34, an ECS (engine control service) 35, a MCS (memory control service) 36, a UCS (user information control service) 37, and a SCS (system control service) 38. The platform 6 includes an API 53 that receives the process request from the application layer 5 with a predetermined function. The OS performs parallel execution of software of the application layer 5 and the platform 6 as processes.

The NCS 31 performs intermediation at the time of allocation of data received via a network by respective protocols to respective applications, or intermediation at the time of transmission of data from each application to the network. For example, the NCS 31 controls data communications with a network apparatus coupled to the multi-functional apparatus 1 via a network.

The DCS 32 controls delivery of document data accumulated in the multi-functional apparatus 1. The OCS 33 controls an operational panel, which is described below.

The FCS 34 provides an API for performing: transmission and reception of facsimile from the application layer 5 using a PSTN or an ISDN network; registration and citation of various kinds of FAX data managed in backup memory; reading of FAX data; and reception and printing of FAX documents.

The ECS 35 controls engine parts of the plotter 11, the scanner 12, and the hardware resources 13. The MCS 36 controls, for example: allocation and release of memory; usage of a HDD; and compression and decompression of image data. The UCS 37 manages user information.

The SCS 38 performs processes such as control of an operations part, display of a system screen, display of an LED, management of the hardware resources, management of the applications, and control of applications.

The SRM 39 controls the system and manages the hardware resources 4, together with the SCS 38. For example, the SRM 39 performs mediation in accordance with an obtaining request from an upper layer that uses the hardware resources 4 such as the plotter 11 and the scanner 12, and controls execution of the hardware resources 4.

More specifically, the SRM 39 determines whether the hardware resources 4 to which the obtaining request is issued are available (whether the hardware resources 4 are being used by other obtaining requests). When available, the SRM 39 notifies the upper layer that the hardware resources 4 are available. The SRM 39 performs scheduling for using the hardware resources 4 with respect to the obtaining request from the higher layer, and directly performs the process requested (e.g., paper transfer and an imaging operation by a printer engine, memory reservation, and file generation).

The handler layer 10 includes a FCUH (FAX control unit handler) 40 and an IMH (image memory handler) 41. The FCUH 40 performs management of a FCU (FAX control unit), which is described below. The IMH 41 performs allocation of memory with respect to processes and management of the memory allocated to the processes. The SRM 39 and the FCUH 40 issue a process request with respect to the hardware resources 4 by using an engine I/F 54, which transmits a process request to the hardware resources 4 with a predetermined function.

With the configuration shown in FIG. 1, the multi-functional apparatus 1 can perform, at the platform 6, a process commonly necessary for each application in a unified manner.

Next, a description is given of the hardware configuration of the multi-functional apparatus 1.

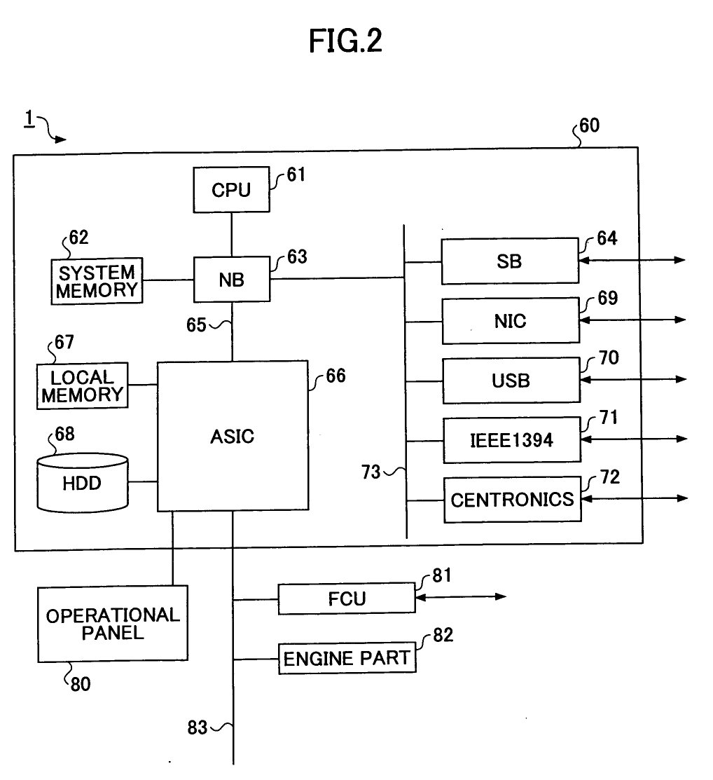

FIG. 2 is a block diagram for explaining the hardware configuration of the multi-functional apparatus 1 according to one embodiment of the present invention. The multi-functional apparatus 1 shown in FIG. 2 includes a controller 60, an operational panel 80, a FCU 81, and an engine part 82.

The controller 60 includes a CPU 61, a system memory 62, a NB (north bridge) 63, a SB (south bridge) 64, an ASIC 66, a local memory 67, a HDD 68, a NIC (network interface card) 69, a USB I/F 70, an IEEE 1394 I/F 71, and a Centronics I/F 72.

The operational panel 80 is coupled to the ASIC 66 of the controller 60. The FCU 81 and the engine part 82 are coupled to the ASIC 66 of the controller 60 via a PCI bus 83.

In the controller 60, the local memory 67 and the HDD 68 are coupled to the ASIC 66, and the CPU 61 and the ASIC 66 are coupled to each other via the NB 63, which is included in a CPU chipset. The ASIC 66 and the NB 63 are coupled to each other via an AGP (Accelerated Graphics Port) 65.

The CPU 61 entirely controls the multi-functional apparatus 1. In the multi-functional apparatus 1 shown in FIG. 1, after the CPU 61 activates: one or more service modules, which form the control service layer 9; the SRM 39; and the FCUH 40 and the IMH 41, which form the handler layer 10, the CPU 61 activates and executes the printer application 21, the copy application 22, the FAX application 23, the scanner application 24, and the network file application 25, which form the application layer 5.

The NB 63 is a bridge for coupling the CPU 61, the system memory 62, the SB 64, the ASIC 66, the NIC 69, the USB I/F 70, the IEEE 1394 I/F 71, and the Centronics I/F 72. The NB 63 is coupled to the SB 64, the NIC 69, the USB I/F 70, the IEEE 1394 I/F 71, and the Centronics I/F 72 via a PCI bus 73. The SB 64 is a bridge for coupling the PCI bus 73 to ROM and peripheral devices, etc.

The system memory 62 is a memory used as, for example, a drawing memory. The local memory 67 is a memory used as, for example, a copying image buffer and a code buffer. The ASIC 66 is an IC for image processing having a hardware element for image processing. The HDD 68 is an example of storage (secondary storage unit) that performs, for example, accumulation of image data, accumulation of document data, accumulation of programs, accumulation of font data, and accumulation of forms.

The NIC 69 is an interface instrument that couples the multi-functional apparatus 1 to a network such as the Internet or a LAN. The USB I/F 70, the IEEE 1394 I/F 71, and the Centronics I/F 72 are interfaces complying with the respective standards. The operational panel 80 receives an input operation from a user and performs display for the user. The FCU 81 includes a backup memory. The memory included in the FCU 81 is used for, for example, temporarily storing facsimile data received when the power of the multi-functional apparatus 1 is OFF.

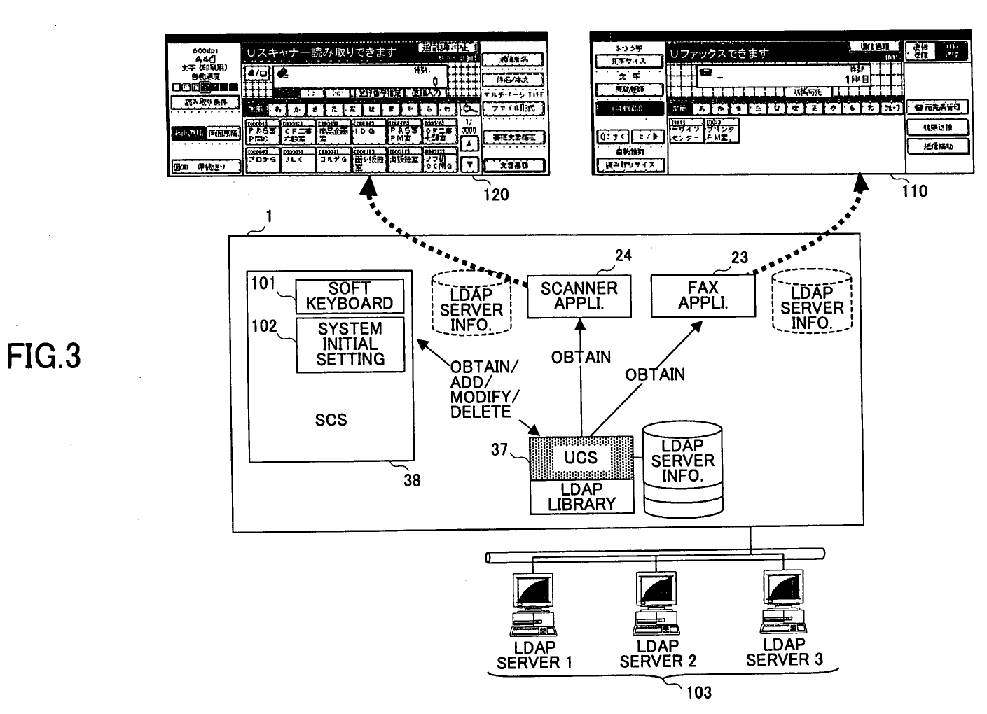

FIG. 3 is a diagram for explaining an obtaining request, an addition request, a modification request, and a deletion request for LDAP server information. It should be noted that those configurations not necessary for explanation are omitted in FIG. 3. The UCS 37 manages the LDAP information in a unified manner. The UCS 37 stores in the HDD 68 and manages, for example, the LDAP server information.

The LDAP server information includes, for example, a server name, a host name (IP address), a port number, a search start position, authentication information, optional search conditions, and a character code as data items. The UCS 37 provides the LDAP server information to the FAX application 23, the scanner application 24, or the SCS 28 in response to an obtaining request from the FAX application 23, the scanner application 24, or the SCS 38, respectively. In addition, the UCS 37 adds, modifies or deletes the LDAP server information in response to an addition request, a modification request, or a deletion request from the SCS 38.

The FAX application 23 obtains LDAP server information of one or more of LDAP servers 103 to be searched by issuing one or more obtaining requests for the LDAP server information to the UCS 37. The FAX application 23 obtains user information required for a FAX function by using the LDAP server information, and displays a screen 110 on the operational panel 80 by using the user information. The screen 110 displays, for example, information (e.g., FAX numbers) for selecting an address to which FAX data are to be transmitted.

The scanner application 24 obtains LDAP server information of one or more of the LDAP servers 103 to be searched by issuing one or more obtaining requests for the LDAP server information to the UCS 37. The scanner application 24 obtains user information required for a scanner function by using the LDAP server information, and displays a screen 120 on the operational panel 80 by using the user information. The screen 120 displays information (e.g., e-mail addresses) for selecting an address to which scanner data are to be transmitted.

A system initial setting function 102 of the SCS 38 obtains, adds, modifies and deletes LDAP server information by issuing, to the UCS 37, an obtaining request, an addition request, a modification request and a deletion request for the LDAP server, respectively. A soft keyboard function 101 of the SCS 38 displays a soft keyboard on the operational panel 80, and controls the soft keyboard.

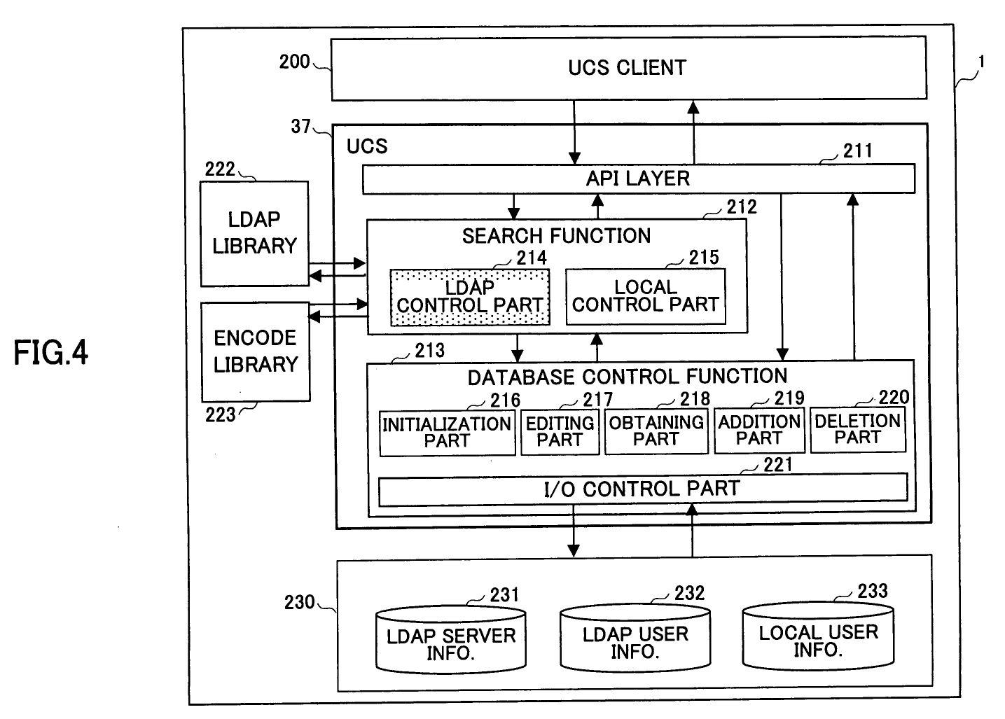

FIG. 4 is a block diagram for explaining an exemplary software configuration of the UCS 37 realizing a search function. It should be noted that those configurations not necessary for explanation are omitted in FIG. 4. The UCS 37 includes an API layer 211, a search function 212, and a database control function 213. The API layer 211 realizes an interface with a UCS client 200 such as the FAX application 23, the scanner application 24, or the SCS 38.

The search function 212 is formed by a LDAP control part 214 and a local control part 215, and realizes a function of searching for data stored in the LDAP servers by using a LDAP library 222 and an encode library 223. In this specification, search of data stored in the LDAP servers is referred to as “the LDAP search”.

The database control function 213 is formed by an initialization part 216, an editing part 217, an obtaining part 218, an addition part 219, a deletion part 220, and an I/O control part 221. The database control function 213 controls LDAP sever information 231, LDAP user information 232, and local user information 233, which are stored in a storing part 230 of, for example, the HDD 68.

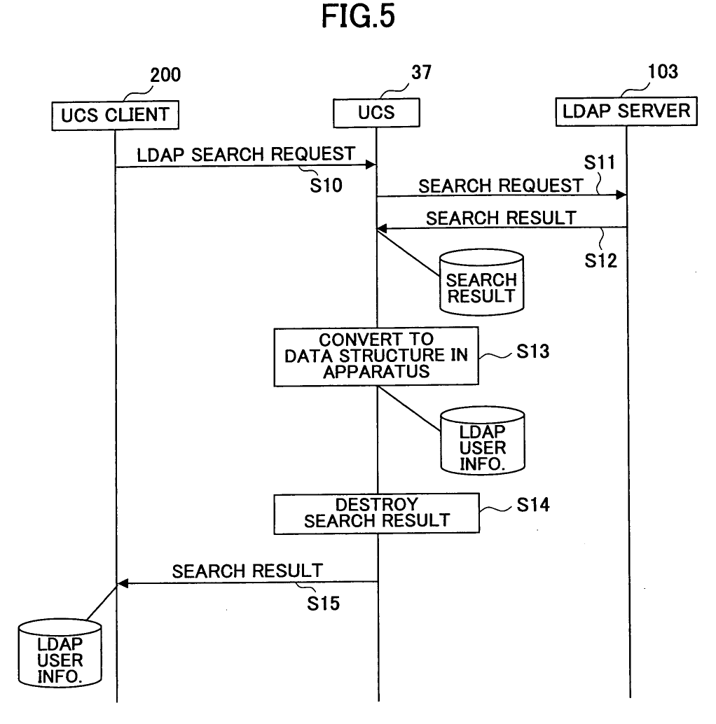

With the use of the multi-functional apparatus 1 having the hardware and software configurations as mentioned above, the LDAP search is performed in a procedure as shown in FIG. 5. FIG. 5 is a sequence diagram of the LDAP search. In step S10, the UCS client 200, such as the FAX application 23 or the scanner application 24, issues a LDAP search request to the UCS 37. It should be noted that, when issuing the LDAP search request to the UCS 37, the UCS client 200 also supplies, to the UCS 37, search target LDAP server information and search information, together with the LDAP search request. The search target LDAP server information includes, for example, a server name, a host name (IP address) and a port number. The search information includes, for example, a search filter, an obtaining attribute and a search start position.

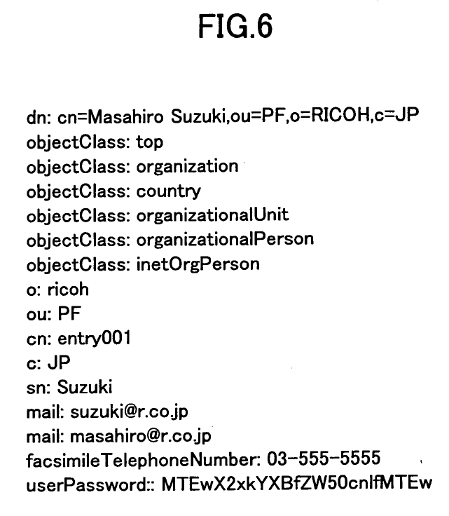

In step S11, the UCS 37 issues one or more search requests in accordance with the search information to one or more of the LDAP servers 103 specified by the search target LDAP server information, which is supplied from the UCS client 200. In step S12, the UCS 37 receives the search result with respect to the search request in step S11. The search result received in step S12 is, for example, information of each entry having a data structure as shown in FIG. 6. FIG. 6 is a data structure diagram of an exemplary search result.

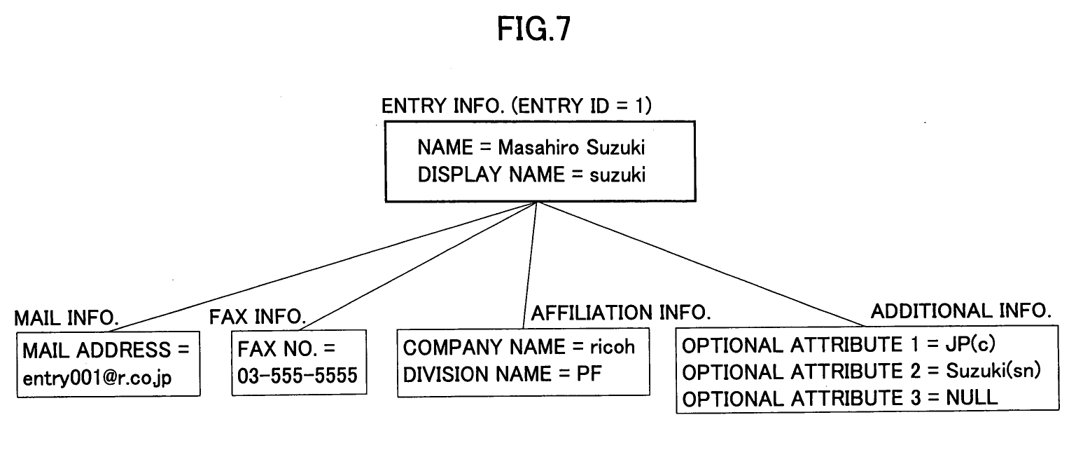

In step S13, the UCS 37 converts the search result as shown in FIG. 6 to a data structure of an entry for the multi-functional apparatus 1 as shown in FIG. 7, thereby generating LDAP user information. FIG. 7 is a data structure diagram of exemplary LDAP user information. In the LDAP user information shown in FIG. 7, mail information, FAX information, affiliation information, and additional information, for example, are associated with entry information, which is identified with an entry ID. It should be noted that the additional information contains one or more attributes that can be arbitrarily set by a user and are obtained from a LDAP server.

In step S14, the UCS 37 deletes the search result as shown in FIG. 6. In step S15, the UCS 37 supplies, to the UCS client 200, the LDAP user information converted in step S13 from the search result as the response to the LDAP search request in step S10.

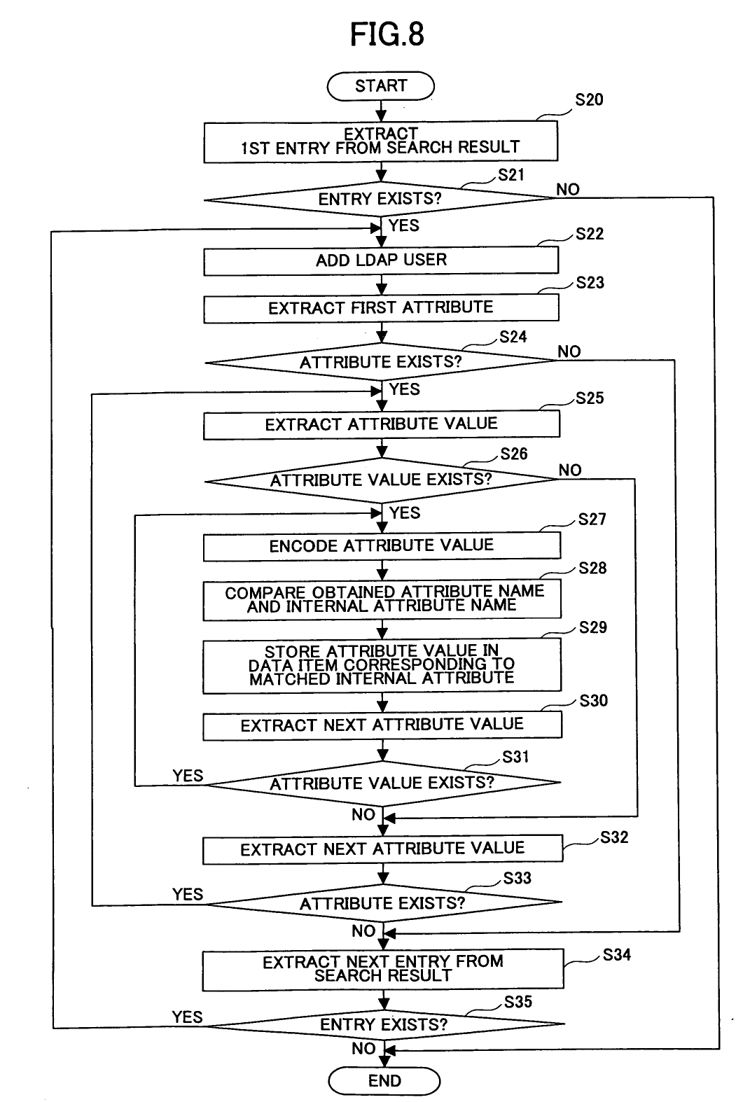

A further description is given of the process in step S13. FIG. 8 is a flowchart of an exemplary process of converting the search result to the data structure of an entry for the multi-functional apparatus 1. In step S20, the UCS 37 extracts a first entry from the search result. In step S21, the UCS 37 determines whether there is an extracted entry (whether the first entry exists).

When there is an extracted entry (YES in step S21), the process proceeds to step S22. In step S22, the UCS 37 adds the extracted entry to LDAP user information as entry information. On the other hand, when no entry is extracted (NO in step S21), the UCS 37 ends the process of FIG. 8.

In step S23, the UCS 37 extracts a first attribute from the entry extracted in step S20. In the case of the search result shown in FIG. 6, for example, the UCS 37 extracts an attribute “cn”. In step S24, the UCS 37 determines whether there is an extracted attribute.

When there is an extracted attribute (YES in step S24), the process proceeds to step S25. In step S25, the attribute value (actual data) of the extracted attribute is extracted. In the case of the search result shown in FIG. 6, for example, the UCS 37 extracts the attribute value “Masahiro Suzuki” of the attribute “cn”. On the other hand, when no attribute is extracted (NO in step S24), the process proceeds to step S34.

In step S26, the UCS 37 determines whether there is an extracted attribute value. When there is an extracted attribute value (YES in step S26), the process proceeds to step S27. In step S27, the UCS 37 performs encoding of the extracted attribute value. The encoding of step S27 is a process of converting the name of the extracted attribute to a character code that can be displayed on the operational panel 80. On the other hand, when no attribute is extracted (NO in step S26), the process proceeds to step S32.

In step S28, the UCS 37 sequentially compares the names of extracted attributes (obtained attributes) (hereinafter referred to as “extracted attribute name”) with the names of attributes for the multi-functional apparatus 1 (hereinafter referred to as “internal attribute name”). In step S29, when the UCS 37 finds an internal attribute name that matches an extracted attribute name, the UCS 37 stores the attribute value in a data item corresponding to the internal attribute name.

In step S30, the UCS 37 extracts the next attribute value of the extracted attribute. In step S31, the UCS 37 determines whether there is another extracted attribute value (whether the next attribute value exists). When there is an extracted attribute value (YES in step S31), the process returns to step S27, and the processes of step S27 through S31 are repeated. On the other hand, when no other attribute value exists (NO in step S31), the process proceeds to step S32.

In step S32, the UCS 37 extracts the next attribute from the entry extracted in step S20. In the case of the search result shown in FIG. 6, for example, the UCS 37 extracts an attribute “ou”. Then, the process proceeds to step S33, where the UCS 37 determines whether there is another extracted attribute.

When there is another extracted attribute (YES in step S33), the process returns to step S25. When no other attribute exists (NO in step S33), the process proceeds to step S34. In the aforementioned manner, the data structure of one entry is converted to the data structure of an entry for the multi-functional apparatus 1.

In step S34, the UCS 37 extracts the next entry from the search result. In step S35, the UCS 37 determines whether there is an extracted entry. When there is an extracted entry (YES in step S35), the process returns to step S22. On the other hand, when no entry is extracted (NO in step S35), the process of FIG. 8 ends.

It is assumed that “text data” is set as an attribute to be used in the multi-functional apparatus 1. Thus, when an unexpected attribute such as binary data (jpegPhoto) is obtained, the multi-functional apparatus 1 uselessly performs a process such as encoding. Accordingly, it takes time for the UCS client 200 to return a search result.

Therefore, the present invention makes it possible to set a data type, such as “text data” or “binary data”, for each attribute and presents the data type of each attribute to a user. When setting one or more attributes to be obtained, the user can set not to obtain an attribute that is not required in the multi-functional apparatus 1 and/or an attribute that takes time for processing, while confirming the data type of each attribute. It should be noted that the user can set, from the operational panel 8, one or more attributes to be obtained. In the present invention, it is possible to perform setting not to obtain an unnecessary attribute and/or a time-consuming attribute at the initiative of the user.

### Embodiment 1

Embodiment 1 of the present invention allows a user to set an attribute not to be obtained, by presenting the data type of each attribute when the user sets an attribute to be obtained as an obtaining attribute. The user can set an attribute having a data type that requires a long processing time, such as binary data, as an attribute not to be obtained.

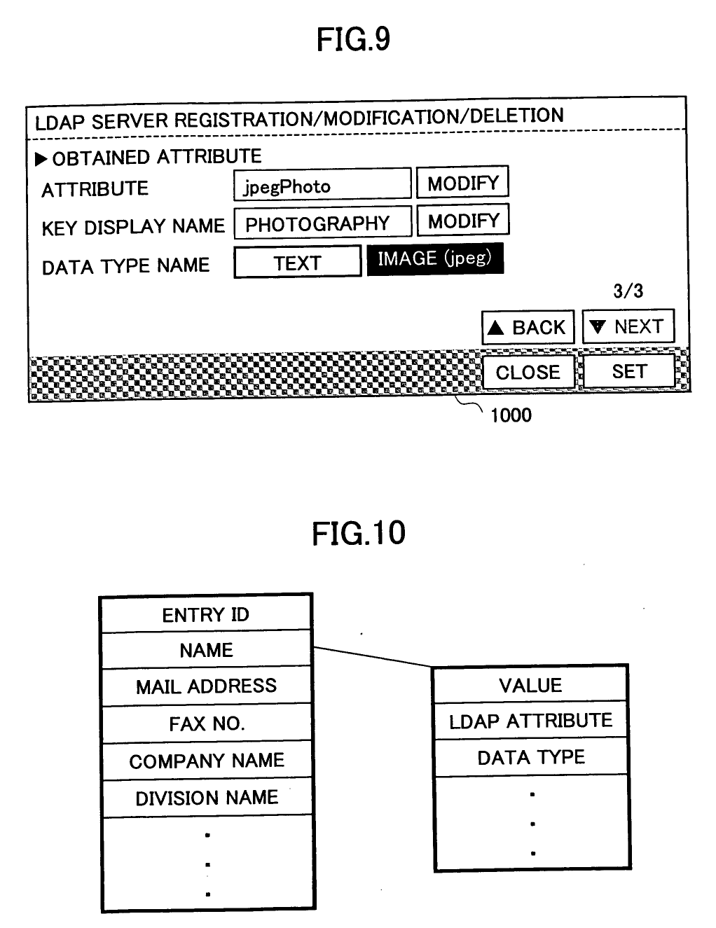

When the user requests for setting of an attribute by operating the operational panel 80, the UCS client 200 displays an attribute setting screen 1000 as shown in FIG. 9 on the operational panel 80. FIG. 9 is a diagram showing an exemplary image of the attribute setting screen for setting an attribute. The attribute setting screen 1000 shown in FIG. 9 includes a field for setting an attribute, a field for setting a key display name, and a selection button for selecting a data type to be set. The attribute setting screen 1000 shown in FIG. 9 is an example where text or image is selected as a data type.

The user sets an attribute, a key display name, and a data type by using the attribute setting screen 100 shown in FIG. 9. That is, with the use of the attribute setting screen 100 shown in FIG. 9, the user can set a data type for each attribute. By setting a data type for each attribute, data types are added as shown in FIG. 10 to LDAP user information as the values of attributes (attribute values) such as a name and a mail address. FIG. 10 is a diagram for explaining the LDAP user information to which data types are added.

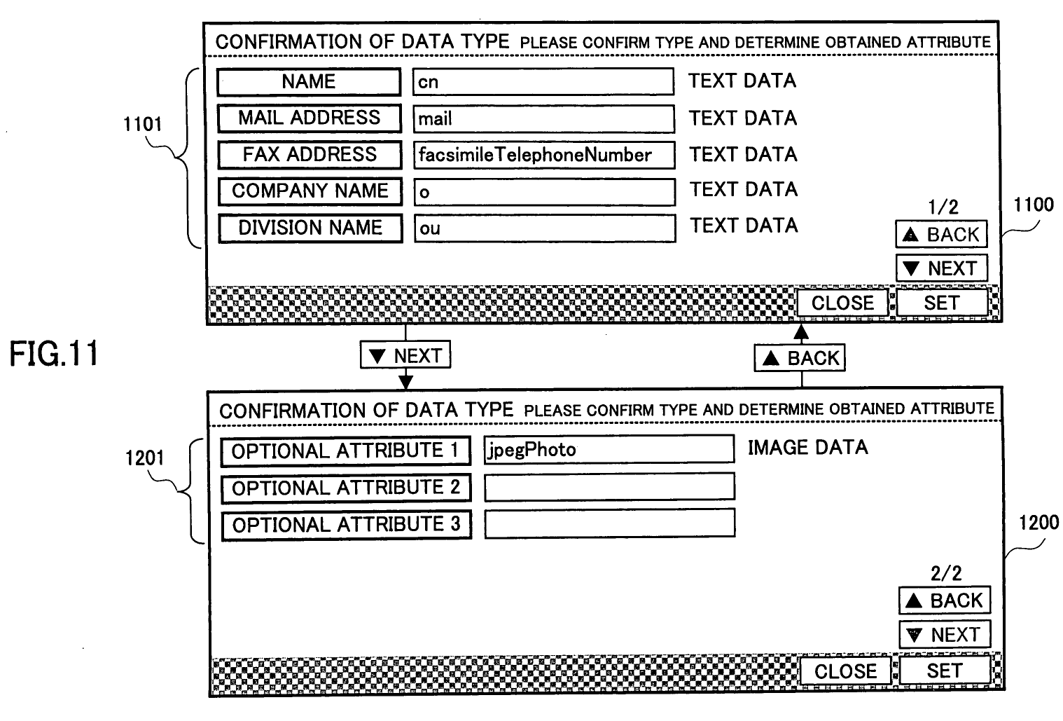

When the user requests for setting an obtaining attribute by operating the operational panel 80, the UCS client 200 displays obtaining attribute setting screens 1100 and 1200 as shown in FIG. 11 on the operational panel operational panel 80. It should be noted that the obtaining attribute setting screen 1200 is displayed when a button “next” of the obtaining attribute setting screen 1100 is pressed. FIG. 11 is a diagram showing exemplary images of the obtaining attribute setting screen for setting an obtaining attribute.

The obtaining attribute setting screens 1100 and 1200 shown in FIG. 11 each includes attributes and the data type of each attribute. By confirming the data type of each attribute, the user can determine whether the attribute is necessary. In the obtaining attribute setting screens 1100 and 1200, the data type of attributes “name”, “mail address”, “FAX address”, “company name” and “division name” is “text data”, and the data type of an attribute “optional attribute 1” is “image data”.

The user can select an attribute to be obtained or not to be obtained by switching non-reversing display and reversing display of attribute buttons 1101 and 1201 by pressing the attribute buttons 1101 and 1201 of the obtaining attribute setting screens 1100 and 1200, respectively.

The user can freely set an attribute not to be obtained, after confirming the data type of each attribute forming an entry, and determining whether the attribute is necessary.

### Embodiment 2

Embodiment 2 of the present invention allows a user to set an attribute not to be obtained, by presenting the data type of each attribute when setting a data type based on a result of pre-search and setting an attribute to be obtained as an obtaining attribute. The user can set an attribute having a data type that requires a long processing time, such as binary data, as an attribute not to be obtained.

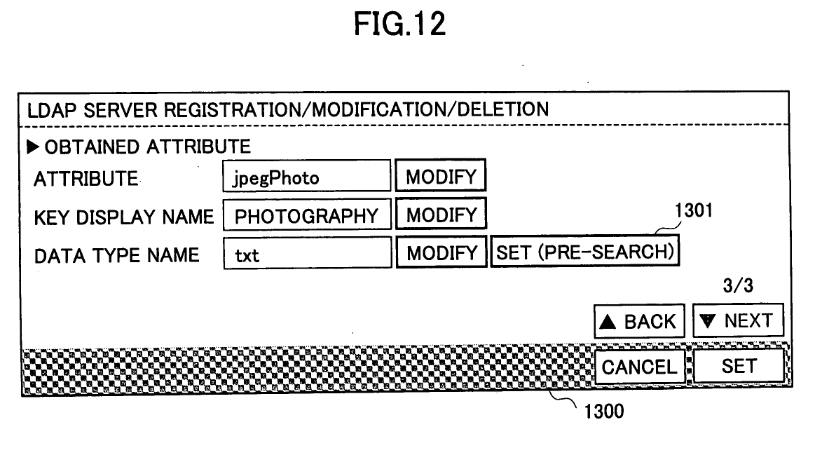

When the user requests for setting an attribute by operating the operational panel 80, the UCS client 200 displays an attribute setting screen 1300 as shown in FIG. 12 on the operational panel 80. FIG. 12 is a diagram showing another exemplary image of the attribute setting screen for setting an attribute. The attribute setting screen 1300 shown in FIG. 12 includes a field for setting an attribute, a field for setting a key display name, a field for setting a data type to be set, and a pre-search button 1301 for executing pre-search. The attribute setting screen 1300 shown in FIG. 12 is an example where a data type “txt” is set based on a result of pre-search for an attribute “jpegPhoto”.

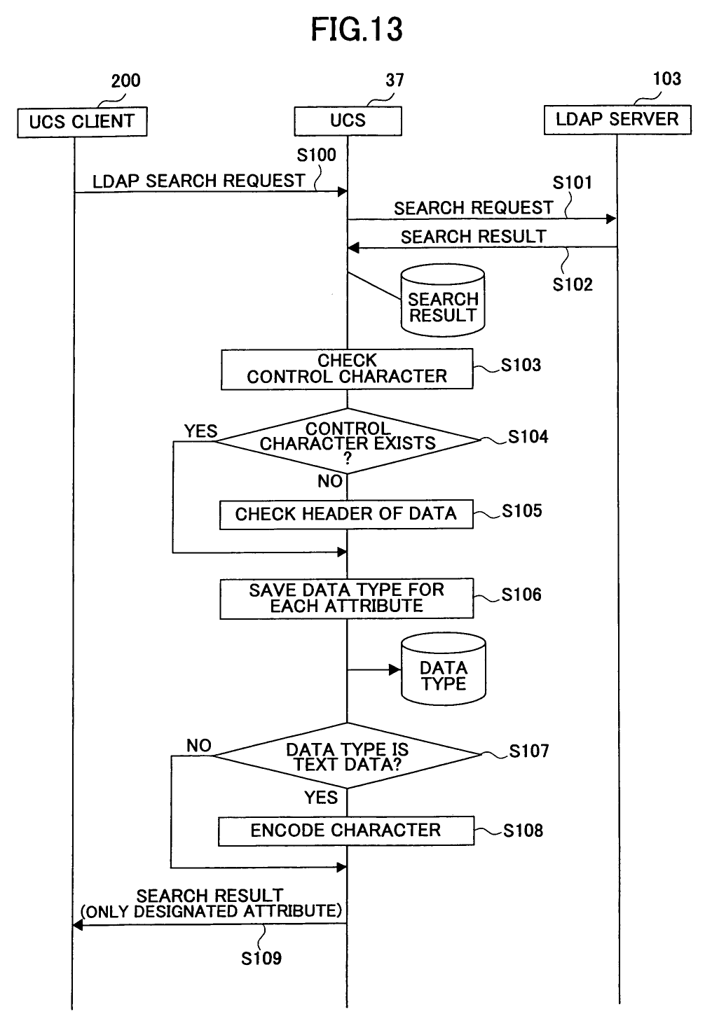

When the user presses down the pre-search button 1301 after setting an attribute and a key display name in the attribute setting screen 1300 shown in FIG. 12, a process as shown in FIG. 13 is initiated. FIG. 13 is a sequence diagram showing an exemplary process for obtaining the data type of a set attribute.

In step S100, the UCS client 200 issues a LDAP search request to the UCS 37. When issuing the LDAP search request to the UCS 37, the UCS client 200 supplies, to the UCS 37, search target LDAP server information and search information, together with the LDAP search request. The search target LDAP server information includes, for example, an IP address/host name and a port number. The search information includes, for example, authentication setting, an authentication user name, an authentication password, and an attribute whose data type is desired to be obtained.

In step S101, the UCS 37 issues a search request in accordance with the search information to the LDAP servers 103 specified by the search target LDAP server information supplied from the UCS client 200. In step S102, the UCS 37 receives the search result corresponding to the search request in step S101.

In step S103, the UCS 37 checks whether a control character only used for an image exists in the received search result. In step S104, based on the check result in step S103, the UCS 37 determines whether the control character exists in the received search result.

When it is determined that the control character exists (YES in step S104), the process proceeds to step S106 after the UCS 37 determines that the data type of an attribute is binary data. On the other hand, when it is determined that the control character does not exist (NO in step S104), the process proceeds to step S105. In step S105, the data type of an attribute is determined by checking the header part of data included in the received search result.

In step S106, the UCS 37 saves the determined data type for each attribute. In step S107, the UCS 37 determines whether the determined data type is text data.

When it is determined that the determined data type is text data (YES in step S107), the process proceeds to step S108. In step S108, the UCS 37 performs character encoding on the search result, and the process proceeds to step S109. On the other hand, when it is determined that the determined data type is not text data (NO in step S107), the process proceeds to step S109 without performing character encoding on the search result by the UCS 37. In step S109, the UCS 37 supplies, to the UCS client 200, the data type of the set attribute as the search result corresponding to the LDAP search request in step S100. The UCS client 200 displays the data type of the attribute read from the search result in a field of the attribute setting screen 1300 shown in FIG. 12, which field is for setting a data type that the user desires to set.

Accordingly, by performing pre-search by setting an attribute and a key display name, the user can readily obtain the data type of the attribute. When the user requests for setting an obtaining attribute by operating the operational panel 80, the UCS client 200 displays the above-mentioned obtaining attribute setting screens 1100 and 1200 on the operational panel 80. By confirming the data type of each attribute in the obtaining attribute setting screens 1100 and 1200, the user can determine whether an attribute is necessary.

The user can freely set an attribute not to be obtained, after confirming the data type of each attribute forming an entry, and determining whether the attribute is necessary.

### Embodiment 3

Embodiment 3 of the present invention allows a user to set an attribute not to be obtained, by presenting the data type of each attribute when causing the user to set a data type by presenting the user the result of pre-search and setting an attribute to be obtained as an obtaining attribute. The user can set an attribute having a data type that requires a long processing time, such as binary data, as the attribute not to be obtained.

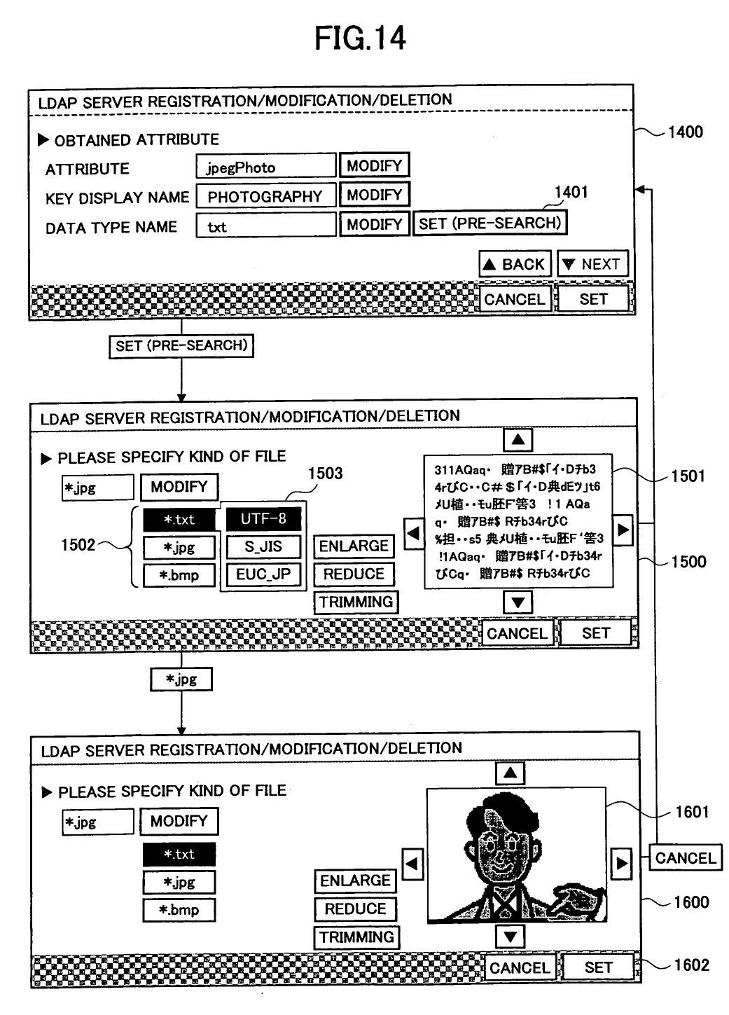

When the user requests for setting an attribute by operating the operational panel 80, the UCS client 200 displays an attribute setting screen 1400 as shown in FIG. 14 on the operational panel 80. Since the attribute setting screen 1400 shown in FIG. 14 is similar to the attribute setting screen 1300 shown in FIG. 12, a description thereof is omitted.

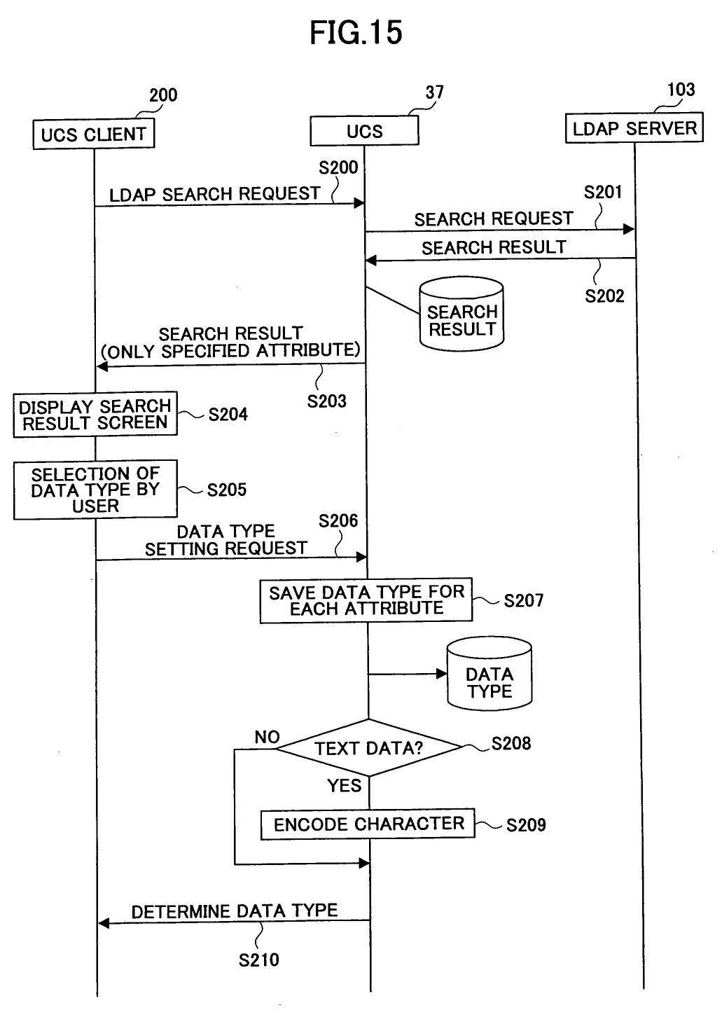

When the user presses down a pre-search button 1401 after setting an attribute and a key display name in the attribute setting screen 1400, a process as shown in FIG. 15 is initiated. FIG. 15 is a sequence diagram of an exemplary process for causing the user to determine the data type of a set attribute. Since the processes of steps S200 through S202 are similar to those of steps S100 through S102 in FIG. 13, a description thereof is omitted.

In step S203, the UCS 37 supplies, to the UCS client 200, the search result corresponding to a LDAP search request in step S200. In step S204, the UCS client 200 displays the search result supplied in step S203 in a search result display field 1501 of a data type setting screen 1500 as shown in FIG. 14.

The data type setting screen 1500 shown in FIG. 14 includes the search result display field 1501, data type selection buttons 1502 for allowing the user to select a data type, and character code selection buttons 1503 for selecting a character code.

The search result display field 1501 displays a search result in accordance with the data type selected with the data type selection buttons 1502. In the case where the selected data type is text data, the search result display field 1501 displays a search result in text data in accordance with a character code selected with the character code selection buttons 1503.

The data type setting screen 1500 shown in FIG. 14 is an example where text data “*. txt” is selected as the data type and “UTF-8” is selected as a character code. The search result display field 1501 shown in FIG. 14 displays meaningless text data, since a correct data type is not selected,.

In step S205, the user confirms the data type setting screen 1500 displayed on the operational panel 80. When the user determines that the data type is not correct, the user selects a data type by pressing one of the data type selection buttons 1502 and one of the character code selection buttons 1503 of the data type setting screen 1500.

When the user selects image data “*. jpg” as the data type, the UCS client 200 displays the search result supplied in step S203 in a search result display field 1601 of a data type setting screen 1600 as shown in FIG. 14. The search result display field 1601 shown in FIG. 14 displays an image having significance, since a correct data type is selected. The user confirms the data type setting screen 1600 displayed on the operational panel 80. When the user determines that the data type is correct, the user presses down a “set” button 1602.

By pressing the “set” button 1602, the user can set a data type selected in the data type setting screen 1600 as the data type of an attribute. In addition, in order to allow enlargement/reduction and trimming of images displayed in the search result display fields 1501 and 1601, the data type setting screens 1500 and 1600, which are shown in FIG. 14, are each provided with an “enlarge” button, a “reduce” button, cursor buttons, and a trimming button.

When the “set” button 1602 is pressed down, the UCS client 200 issues, to the UCS 37, a data type setting request for setting a data type selected in the data type setting screen 1600. Since the processes of steps S207 through S209 are similar to those of steps S106 through S108, a description thereof is omitted. In step S210, the UCS 37 supplies a data type determined response with respect to the data type setting request in step S206.

Accordingly, the user can select a data type that the user regards as appropriate by varying the data type of the search result displayed in the data type setting screens 1500 and 1600. In addition, when the user requests for setting an obtaining attribute by operating the operational panel 80, the UCS client 200 displays the above-mentioned obtaining attribute setting screens 1100 and 1200 on the operational panel 80. By confirming the data type of each attribute in the obtaining attribute setting screens 1100 and 1200, the user can determine whether the attribute is necessary.

The user can freely set an attribute not to be obtained, after confirming the data type of each attribute forming an entry, and determining whether the attribute is necessary.

Methods for setting a data type include the methods as follows. First, the data type of an attribute may be set by registering in advance the relationships between attributes that are likely to be set by a user and the data types of the attributes as a dictionary, and by using the dictionary. A sub-schema entry and a list of schemas defined in the RFC include a lot of descriptions of attributes not used in the multi-functional apparatus 1. Thus, there is a high probability that useless information is maintained. Hence, an attribute that is likely to be set by the user is estimated, a schema table of the attribute is maintained as a dictionary and used for setting a data type. As for attributes not registered in the dictionary, the data types may be extracted from the sub-schema entry or the schema list defined in the RFC. Second, the data type of an attribute may be set by registering the relationships between attributes that are previously set by the user and the data types as a dictionary, for example, and by using the dictionary.

### Embodiment 4

Embodiment 4 of the present invention allows a user to set an attribute not to be obtained, by presenting the data type of each attribute when setting the data type by combining the processes described in the above Embodiments 2 and 3, and setting an attribute to be obtained as an obtaining attribute. The user can set an attribute having a data type that requires a long processing time, such as binary data, as the attribute not to be obtained.

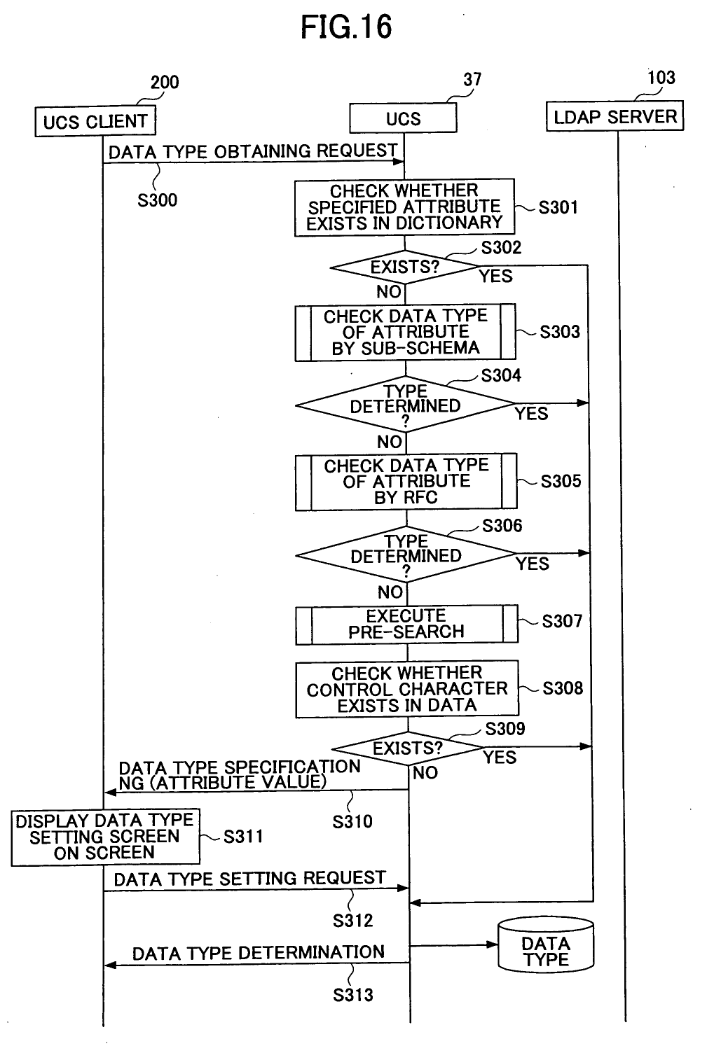

FIG. 16 is a sequence diagram of an exemplary process for obtaining the data type of a set attribute with a plurality of methods. It should be noted that the sequence diagram shown in FIG. 16 is merely an example, and other combinations of methods for setting a data type may be possible.

When the user requests for setting an attribute by operating the operational panel 80, the UCS client 200 displays, for example, the attribute setting screen 1400 shown in FIG. 14 on the operational panel 80. When the pre-search button 1401 is pressed down after the user sets an attribute and a key display name in the attribute setting screen 1400, a process as shown in FIG. 16 is initiated.

In step S300, the UCS client 200 issues a data type obtaining request to the UCS 37. When issuing the data type obtaining request to the UCS 37, the UCS client 200 supplies, to the UCS 37, the search target LDAP server information and the search information, together with the data type obtaining request. The search target LDAP server information includes, for example, an IP address/host name and a port number. The search information includes, for example, authentication setting, an authentication user name, an authentication password, and an attribute whose data type the user desires to obtain.

In step S301, the UCS 37 checks whether the attribute supplied with the data type obtaining request exists in the above-mentioned dictionary. In step S302, the UCS 37 determines whether the attribute exists in the dictionary. When the UCS 37 determines that the attribute exists in the dictionary (YES in step S302), the process proceeds to step S313 after setting the data type of an attribute with the use of the dictionary. On the other hand, when the UCS 37 determines that the attribute does not exist in the dictionary (NO in step S302), the process proceeds to step S303.

In step S303, the UCS 37 checks whether the data type of an attribute can be determined with the use of a sub-schema entry. In step S304, the UCS 37 determines whether the data type can be determined with the use of a sub-schema entry. When the UCS 37 determines that the data type can be determined (YES in step S304), the process proceeds to step S313 after setting the data type of an attribute with the use of the sub-schema entry. On the other hand, when the UCS 37 determines that the data type cannot be determined (NO in step S304), the process proceeds to step S305.

In step S305, the UCS 37 checks whether the data type of an attribute can be determined with the use of a list of schemas defined in the RFC. In step S306, the UCS 37 determines whether the data type of an attribute can be determined with the use of the list of schemas defined in the RFC. When the UCS 37 determines that the data type can be determined (YES in step S306), the process proceeds to step S313 after setting the data type of an attribute with the use of the list of schemas defined in the RFC. On the other hand, when the UCS 37 determines that the data type cannot be determined (NO in step S306), the process proceeds to step S307.

In step S307, the UCS 37 executes pre-search as mentioned above. In step S308, the UCS 37 checks whether a control character used only in an image exists in the search result. In step S309, the UCS 37 determines whether a control character used only in an image exists in the search result. When the UCS 37 determines that such a control character exists (YES in step S309), the process proceeds to step S313 after setting “image data” as the data type of the attribute. On the other hand, when the UCS 37 determines that such a control character does not exist (NO in step S309), the process proceeds to step S310. In step S310, the UCS 37 supplies, to the UCS client 200, a data type specification NG and the search result as the response to the data type obtaining request in step S300.

In step S311, the UCS client 200 displays the data type setting screen 1500 as shown in FIG. 14 on the operational panel 80. The user performs selection of a data type by pressing down one of the data type selection buttons 1502 and one of the character code selection buttons 1503 of the data type setting screen 1500 until the user determines that the data type is correct by confirming the data type setting screen 1500 displayed on operational panel 80.

When the “set” button 1602 is pressed down by the user, the process proceeds to step S312. In step S312, the UCS client 200 issues, to the UCS 37, a data type setting request for setting the data type selected in the data type setting screen 1600. In step S313, the UCS 37 supplies a data type determined response with respect to the data type setting request in step S312 after saving the set data type for each attribute.

The user can freely set an attribute not to be obtained, after confirming the data type of each attribute forming an entry, and determining whether the attribute is necessary.

### Embodiment 5

In the above-mentioned Embodiments 1 through 4, the processing time is reduced by setting an attribute having a data type that requires a long processing time due to, for example, a large data size not to be obtained. In Embodiment 5, the processing time is reduced by separately issuing search requests to one or more of the LDAP servers 103 in accordance with data types.

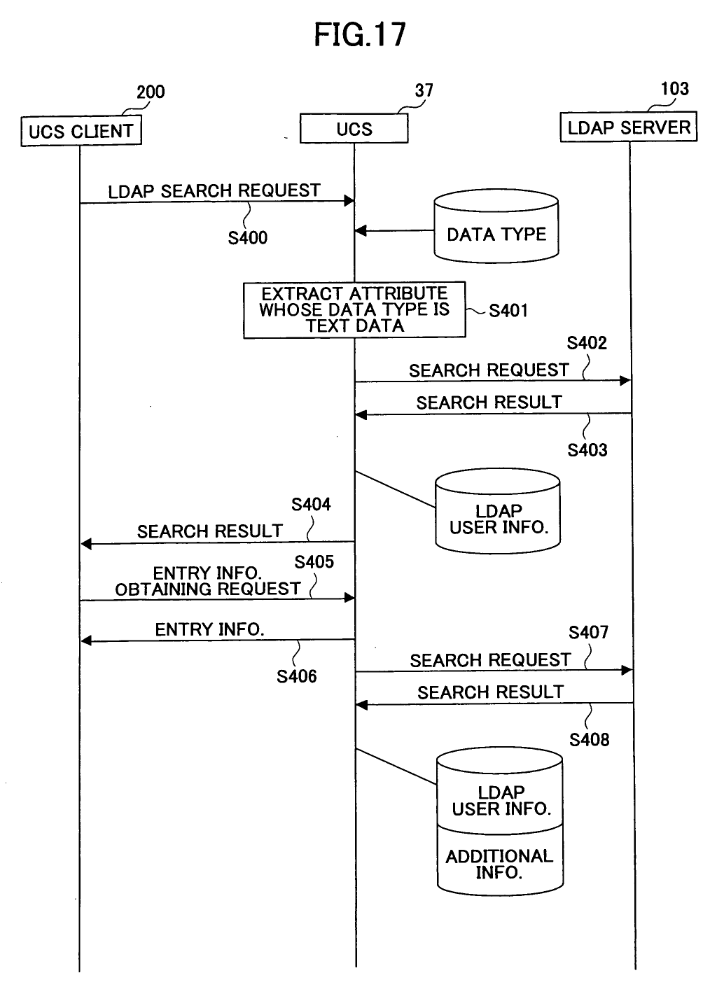

FIG. 17 is a sequence diagram of an example of the LDAP search according to the present invention. In the LDAP search shown in FIG. 17, a time period required until a LDAP search result screen is displayed on the operational panel 80 is reduced by separately issuing search results to the LDAP servers in accordance with data types.

In step S400, the UCS client 200 issues a LDAP search request to the UCS 37. In step S401, the UCS client 200 obtains the data type of an obtaining attribute, which serves as a search target, and extracts the obtained attribute having “text data” as its data type. In step S402, the UCS 37 issues a search request for the obtaining request extracted in step S401 to the LDAP servers 103 specified by the search target LDAP server information supplied from the UCS client 200. In step S403, the UCS 37 receives the search result corresponding to the search request in step S402.

In step S404, the UCS 37 supplies an entry ID to the UCS client 200 as the search result. In step S405, the UCS client 200 issues an entry information obtaining request to the UCS 37. In step S406, the UCS client 200 obtains, from the UCS 37, entry information corresponding to the entry ID. Here, an attribute that the UCS client 200 obtains is an attribute having the data type of “text data”.

For example, when the LDAP search result screen is formed by an attribute having the data type of “text data”, the UCS client 200 can quickly display the LDAP search result screen with the use of the attribute obtained in step S406.

In step S407, the UCS 37 issues a search request to the LDAP servers 103 specified by the search target LDAP server information supplied from the UCS client 200. The obtaining attribute that becomes a search target in step S407 is an attribute having the data type other than “text data”, such as “binary data”. In step S408, the UCS 37 receives the search result corresponding to the search request in step S407.

In the LDAP search of FIG. 17, the LDAP search result screen is displayed by first obtaining an attribute having the data type that requires a short processing time, such as “text data”. Then, the rest of the attributes are obtained while displaying the LDAP search result screen.

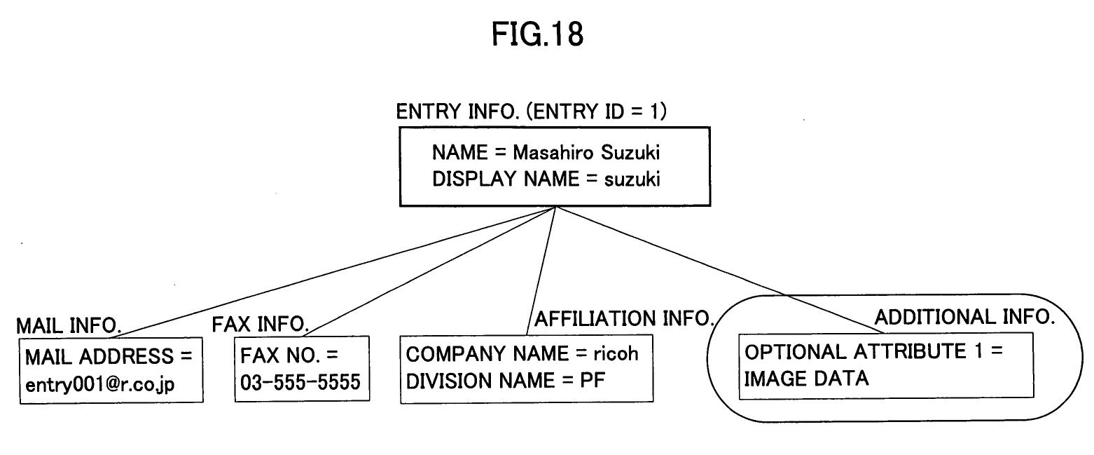

FIG. 18 is a data structure diagram for explaining the difference between the search result obtained first and the search result obtained later. As for the LDAP user information represented in the data structure diagram of FIG. 18, entry information, mail information, FAX information, and affiliation information, which are identified by an entry ID, are obtained from the search result in step S403. Further, additional information is obtained from the search result in step S408.

By separately issuing search requests to the LDAP servers 103 in accordance with data types, the user can reduce the time period required until the search result screen is displayed.

### Embodiment 6

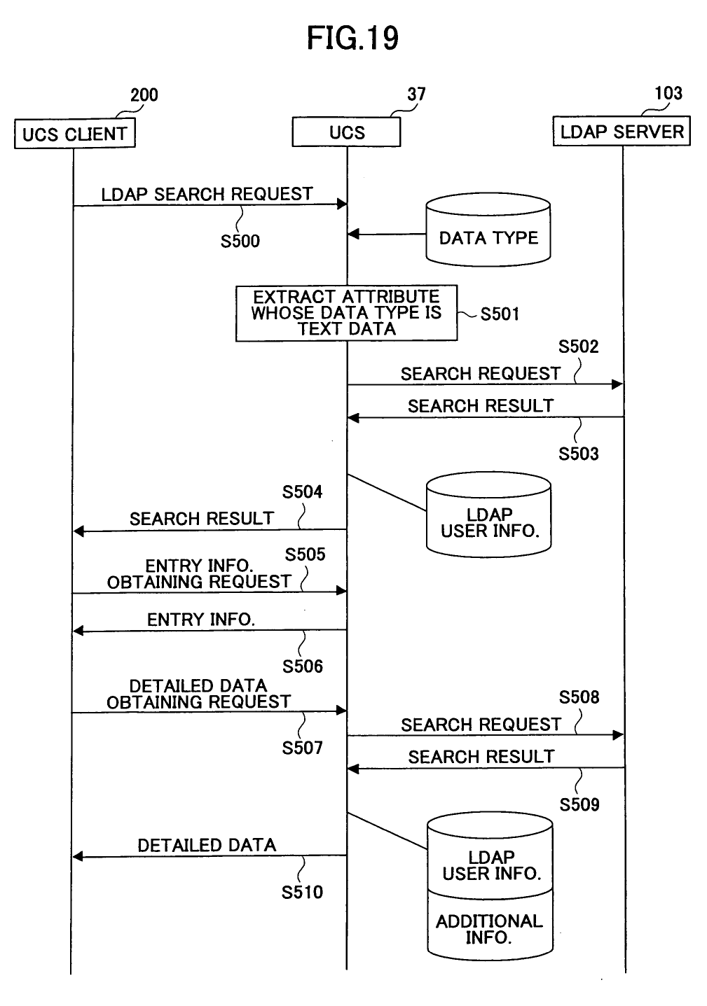

In Embodiment 6 of the present invention, one or more search requests to one or more of the LDAP servers 103 are separately issued in accordance with the data types, and remaining attributes are obtained upon request. FIG. 19 is a sequence diagram of an example of the LDAP search according to the present invention. In the LDAP search shown in FIG. 19, the time period required for displaying the LDAP search result screen on the operational panel 80 is reduced by separately issuing one or more search requests to one or more of the LDAP servers 103 in accordance with the data types, and by obtaining one or more remaining attributes upon a request.

Since the processes of steps S500 through S506 are similar to those of steps S400 through S406, a description thereof is omitted. In step S507, the UCS client 200 issues a detailed data obtaining request to the UCS 37. That is, the UCS 37 does not perform the LDAP search for the remaining attributes until there is the detailed data obtaining request from the UCS client 200.

When the detailed data obtaining request is supplied, the process proceeds to step S508. In step S508, the UCS 37 issues the remaining search requests of the LDAP search requests in step S500. The data types of one or more obtaining attributes to be searched for in step S508 are other than text data, i.e., binary data etc. In step S509, the UCS 37 receives the search result corresponding to the search request in step S508. In step S510, the UCS 37 supplies the search result received in step S509 to the UCS client 200 as detailed data.

In the LDAP search shown in FIG. 19, the LDAP search result screen is displayed by first obtaining an attribute having a data type that requires a short processing time, such as text data. Then, the remaining attributes are obtained upon a request from the UCS client 200. Accordingly, it is possible to avoid obtaining unnecessary attributes.

The user can reduce the time period until the search result screen is displayed, by separately issuing one or more search requests to one or more of the LDAP servers 103 in accordance with the data types, and by obtaining one or more remaining attributes upon request.

### Embodiment 7

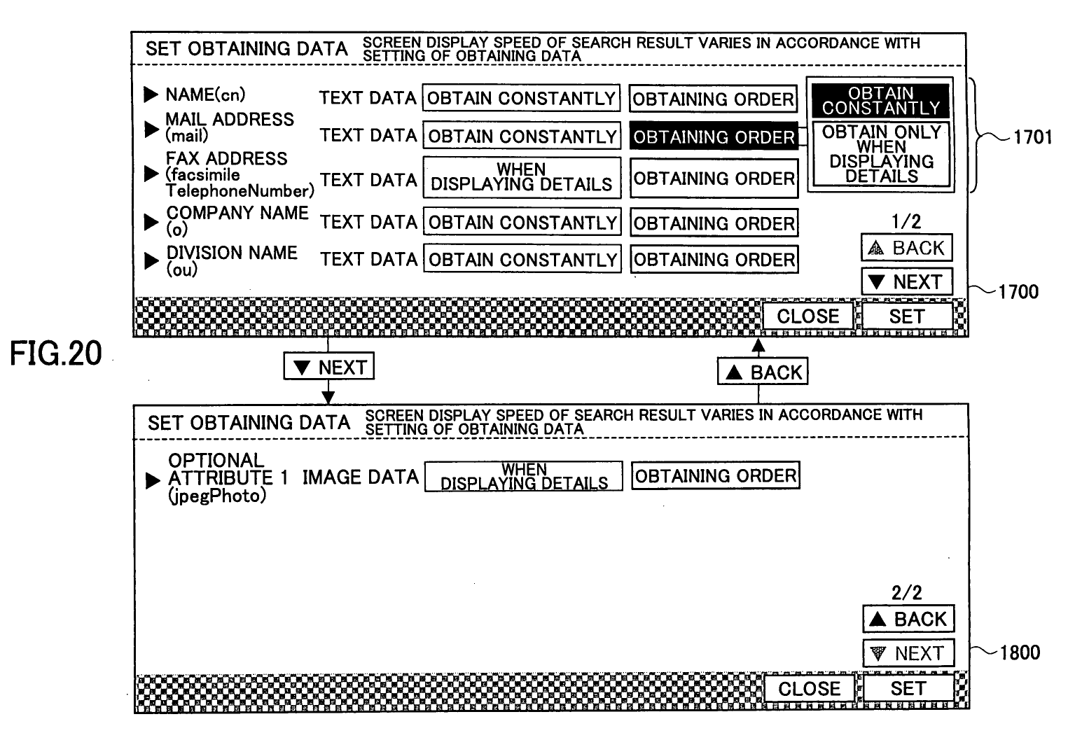

In Embodiment 7 of the present invention, when separately issuing one or more search requests to one or more of the LDAP servers 103 in accordance with the data types, the user manually modifies an obtaining order of attributes. FIG. 20 is a diagram showing images of obtaining order setting screens for setting the obtaining order of attributes.

When the user requests for setting the obtaining order of attributes by operating the operational panel 80, the UCS client 200 displays obtaining order setting screens 1700 and 1800 as shown in FIG. 20. The obtaining order setting screen 1800 is displayed when a “next” button of the obtaining order setting screen 1700 is pressed down. The obtaining order setting screens 1700 and 1800 shown in FIG. 20 include one or more obtaining attributes, the data types of the obtaining attributes, obtaining orders, and an obtaining order modification button 1701 for modifying the obtaining order.

In the obtaining order setting screens 1700 and 1800 shown in FIG. 20, it is possible to set “obtain constantly” or “obtain only when displaying details” for each obtaining attribute as the obtaining order. Since those obtaining attributes set to “obtain only when displaying details” are obtained only when displaying details, it is possible to avoid obtaining unnecessary attributes. Since the data type is displayed for each obtaining attribute in the obtaining order setting screens 1700 and 1800 shown in FIG. 20, it is possible for the user to set an obtaining order of attributes in consideration of reduction of the time period until the LDAP search result screen is displayed.

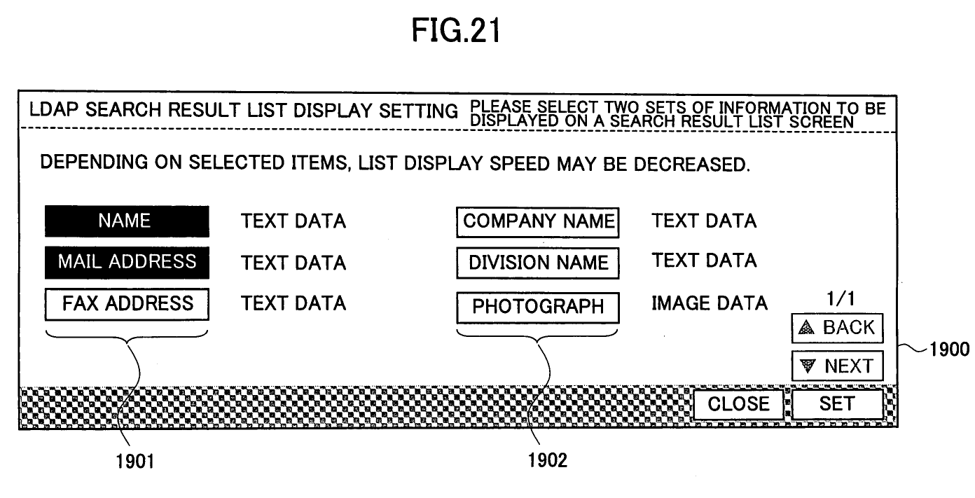

In addition, FIG. 21 is a diagram showing another image of the obtaining order setting screen for setting the obtaining order of attributes. When the user requests for setting the obtaining order of attributes by operating the operational panel 80, the UCS client 200 displays an obtaining order setting screen 1900 as shown in FIG. 21 on the operational panel 80. The obtaining order setting screen 1900 shown in FIG. 21 includes: buttons 1901 and 1902 representing obtaining attributes; and the data types of the obtaining attributes.

The user can select an attribute to be obtained by switching non-reversing display and reversing display of the buttons 1901 and 1902 by pressing down the buttons 1901 and 1902 of the obtaining order setting screen 1900. Since the data type is displayed for each obtaining attribute in the obtaining order setting screen 1900, the user can set an obtaining order of attributes in consideration of reduction of the time period until the LDAP search result screen is displayed. In FIG. 21, attributes “name” and “mail address”, having the data type of “text data”, are selected as obtaining attributes.

### Embodiment 8

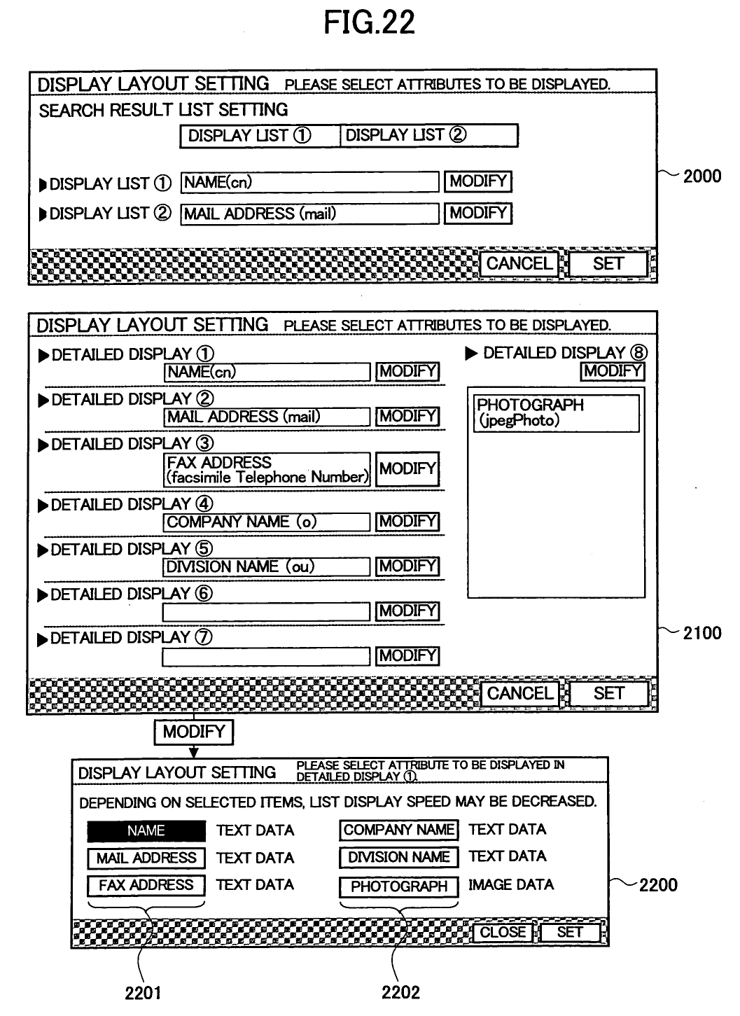

In Embodiment 8 of the present invention, the user manually modifies the display layout (screen layout) of the LDAP search result screen. FIG. 22 is a diagram showing images of a display layout setting screen. A display layout setting screen 2000 is used for setting the display layout of a LDAP search result list screen. A display layout setting screen 2100 is for setting the display layout of a LDAP search result detail screen.

When the user requests for setting of the display layout of the LDAP search result list screen by operating the operational panel 80, the UCS client 200 displays, on the operational panel 80, a display layout setting screen the UCS client 200 as shown in FIG. 22. The display layout setting screen 2000 shown in FIG. 22 includes fields for setting attributes to be displayed in the LDAP search result list screen. The user can modify the attributes to be displayed in the LDAP search result list screen by setting the attributes in the field for setting attributes in the display layout setting screen 2000.

When the user requests for setting of the display layout of the LDAP search result detailed screen by operating the operational panel 80, the UCS client 200 displays, on the operational panel 80, a display layout setting screen 2100 as shown in FIG. 22. The display layout setting screen 2100 shown in FIG. 22 includes fields for setting attributes to be displayed in the LDAP search result detailed screen. The user can modify the attributes displayed in the LDAP search result detailed screen by setting the attributes in the field for setting attributes in the display layout setting screen 2100.

A display layout setting screen 2200 shown in FIG. 22 is for setting attributes in the field for setting attributes in the display layout setting screens 2000 and 2100. The user can set attributes in the field for setting attributes in the display layout setting screens 2000 and 2100 by switching normal display and reversing display of buttons 2201 and 2202 in the display layout setting screen 2200.

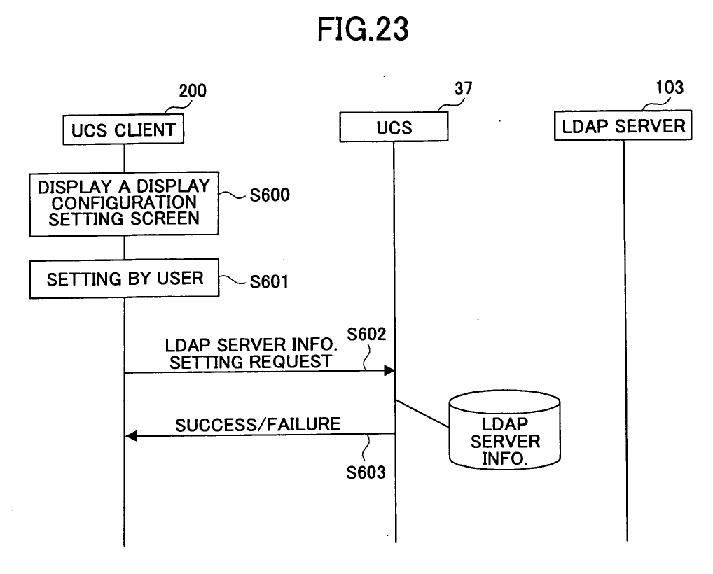

FIG. 23 is a sequence diagram of an exemplary process of modifying the display layout of the LDAP search result screen. In step S600, the UCS client 200 displays, on the operational panel 80, the display layout setting screens 2000 and 2100 shown in FIG. 22. In step S601, the user sets attributes in the field for setting attributes in the display layout setting screens 2000 and 2100.

In step S602, the UCS client 200 issues a LDAP server information setting request to the UCS 37. In this step, the UCS client 200 supplies, to the UCS 37, search target LDAP server information and setting information, together with the LDAP server information setting request. The search target LDAP server information includes, for example, an IP address/host name, and a port number. The setting information includes, for example, authentication setting, an authentication user name, an authentication password, attribute information, and display layout information.

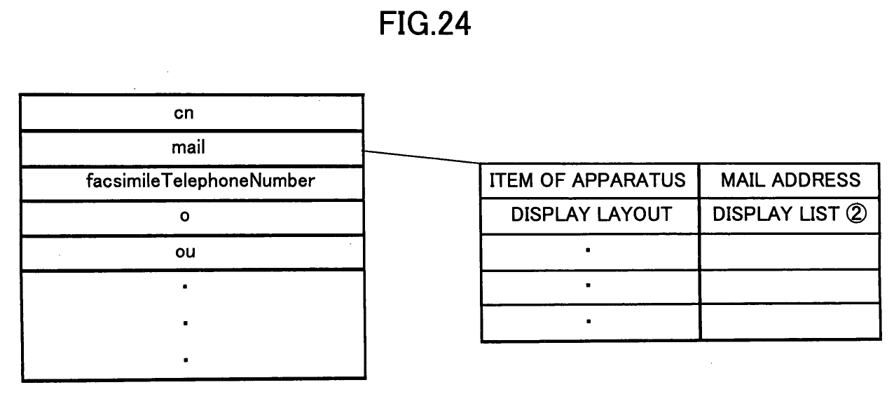

In accordance with the setting information supplied in step S602, the UCS 37 associates, as shown in FIG. 24, attributes with items of the multi-functional apparatus 1 corresponding to the attributes and the display layout information for displaying the attributes. FIG. 24 is a diagram for explaining the process of associating attributes with items of the multi-functional apparatus 1 corresponding to the attributes and the display information for displaying the attributes.

In step S603, the UCS 37 supplies, to the UCS client 200, whether the association with the items of the multi-functional apparatus 1 corresponding to the attributes and the display layout information for displaying the attributes succeeds, as the response to the LDAP server information setting request in step S602.

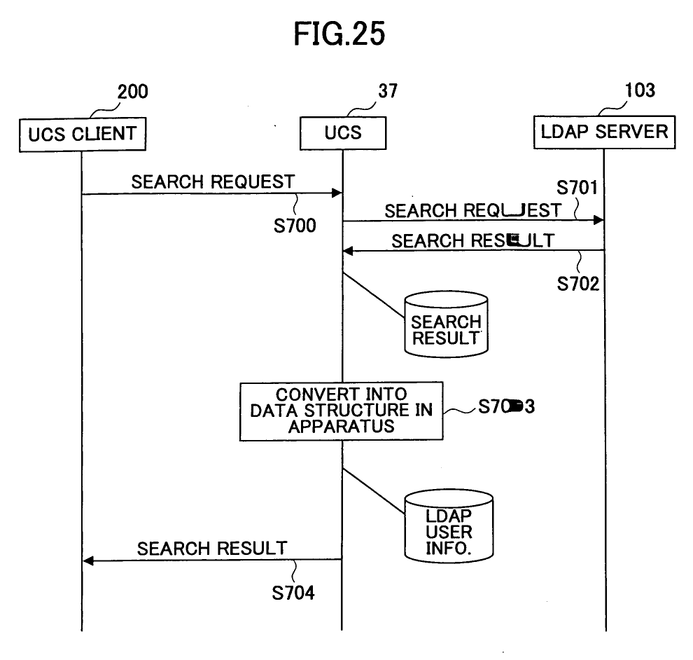

The LDAP search result screen of which display layout is modified is used in the LDAP search as shown in a sequence diagram of FIG. 25. FIG. 25 is a sequence diagram of an example of the LDAP search. In step S700, the UCS client 200 issues a LDAP search result to the UCS 37. When issuing the LDAP search request to the UCS 37, the UCS client 200 supplies, to the UCS 37, search target LDAP server information and search information, together with the LDAP search request.

In step S701, the UCS 37 issues a search request corresponding to the search information to one or more of the LDAP servers 103 that are specified in the search target LDAP server information supplied from the UCS client 200. In step S702, the UCS 37 receives the search result corresponding to the search request in step S701. The search result received in step S702 is, for example, information of each entry having a data structure as shown in FIG. 6.

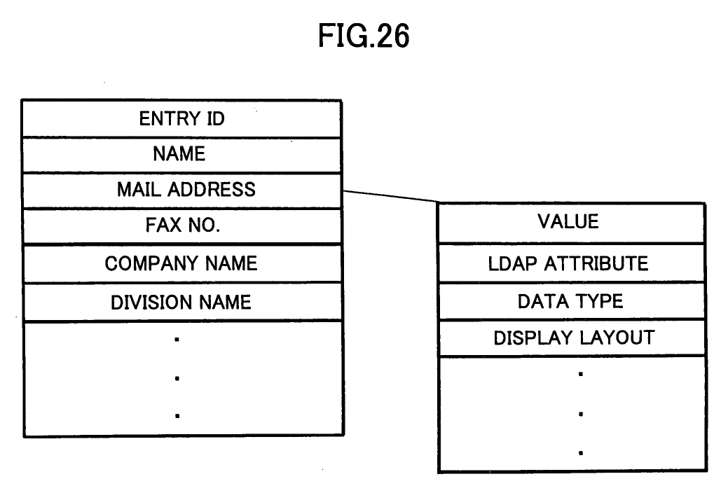

In step S703, the UCS 37 converts the search result as shown in FIG. 6 to the data structure of an entry for the multi-functional apparatus as shown in FIG. 7, thereby generating LDAP user information. That is, display configuration information (display layout information) is added to the LDAP user information as modification of the value of attributes (attribute values) such as a name and a mail address. FIG. 26 is a diagram for explaining the LDAP user information to which the display layout information is added.

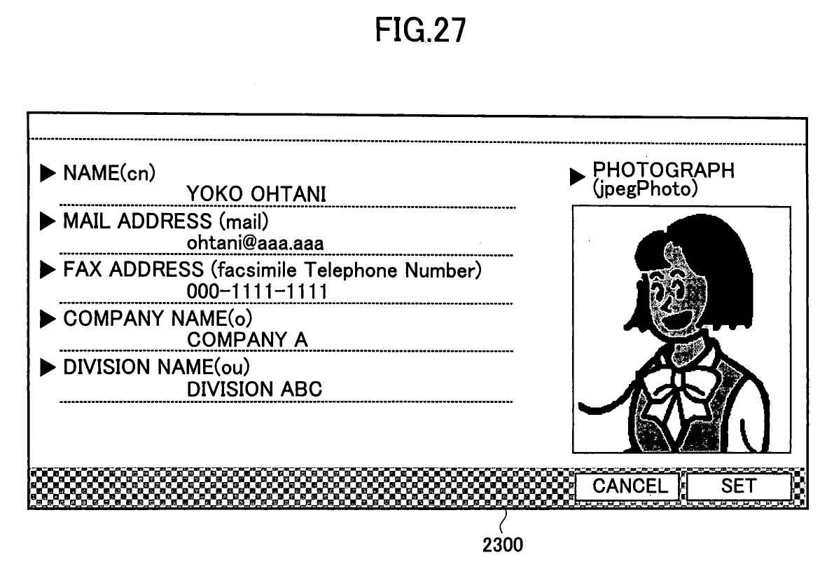

In step S704, the UCS 37 supplies, to the UCS client 200, the LDAP user information converted in step S703 from the search result as the response to the LDAP search request in step S700. Based on the response supplied in step S704 to the LDAP search request, the UCS client 200 displays, on the operational panel 80, a LDAP search result detailed screen 2300 as shown in FIG. 27.

FIG. 27 is a diagram showing an exemplary image of the LDAP search result detailed screen. The display layout of a LDAP search result detailed screen 2300 shown in FIG. 27 corresponds to the attributes specified in the display layout setting screen 2100 shown in FIG. 22.

The user can manually modify the display configuration (display layout) of the LDAP search result screen.

### Embodiment 9

In Embodiment 9 of the present invention, the multi-functional apparatus 1 automatically modifies the display configuration (layout) of the LDAP search result screen. A description is given below of several exemplary methods for automatically modifying the display layout of the LDAP search result screen.

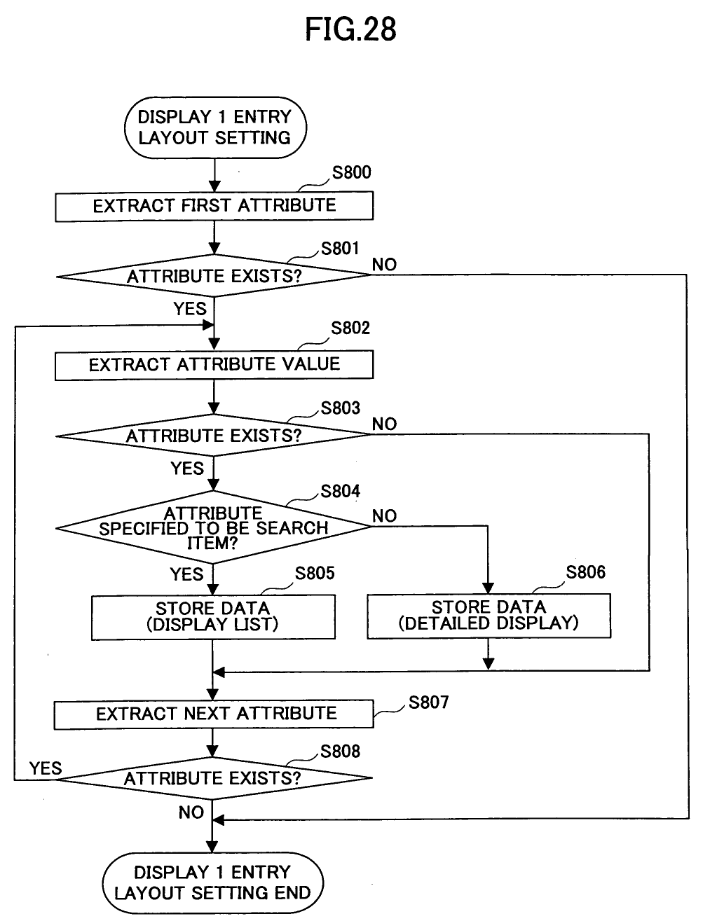

FIG. 28 is a flowchart for explaining an exemplary process of modifying the display layout of the LDAP search result screen in accordance with items that are input as search conditions. The process shown in FIG. 28 is performed, for example, as a part of the process of step S13 shown in FIG. 5.

In step S800, the UCS 37 extracts a first attribute from one entry. In step S801, the UCS 37 determines whether there is an extracted attribute. When it is determined that there is an extracted attribute (YES in step S801), the process proceeds to step S802. In step S802, the UCS 37 extracts the attribute value (actual data) of the extracted attribute. On the other hand, when it is determined that no attribute is extracted (NO in step S801), the UCS 37 ends the process of FIG. 28.

In step S803, the UCS 37 determines whether there is an extracted attribute value. When there is an extracted attribute value (YES in step S803), the process proceeds to step S804, where the UCS 37 determines whether the extracted attribute is the attribute specified in the search items.

When the extracted attribute is the attribute specified in the search items (YES in step S804), the process proceeds to step S805. In step S805, the UCS 37 sets the extracted attribute to the attribute to be displayed in the LDAP search result list screen, and thereafter the process proceeds to step S807. On the other hand, when the extracted attribute is not the attribute specified in the search items (NO in step S804), the process proceeds to step S806. In step S806, the UCS 37 sets the extracted attribute to the attribute to be displayed in the LDAP search result detailed screen, and thereafter the process proceeds to step S807. When no attribute value is extracted (NO in step S803), the process proceeds to step S807.

In step S807, the UCS 37 extracts the next attribute from the entry. In step S808, the UCS 37 determines whether there is an extracted attribute. When there is an extracted attribute (YES in step S808), the process returns to step S802. When no attribute is extracted (NO in step S808), the UCS 37 ends the process of FIG. 28.

In the aforementioned manner, it is possible to modify the display layout of the LDAP search result screen by dividing the attributes forming one entry into the LDAP search result list screen and the LDAP search result detailed screen in accordance with the items that are input as search conditions.

In step S804, attributes are divided into the LDAP search result list screen and the LDAP search result detailed screen depending on whether the extracted attribute is specified in the search items. However, attributes may be divided into the LDAP search result list screen and the LDAP search result detailed screen depending on whether the extracted attribute is often specified as a search item.

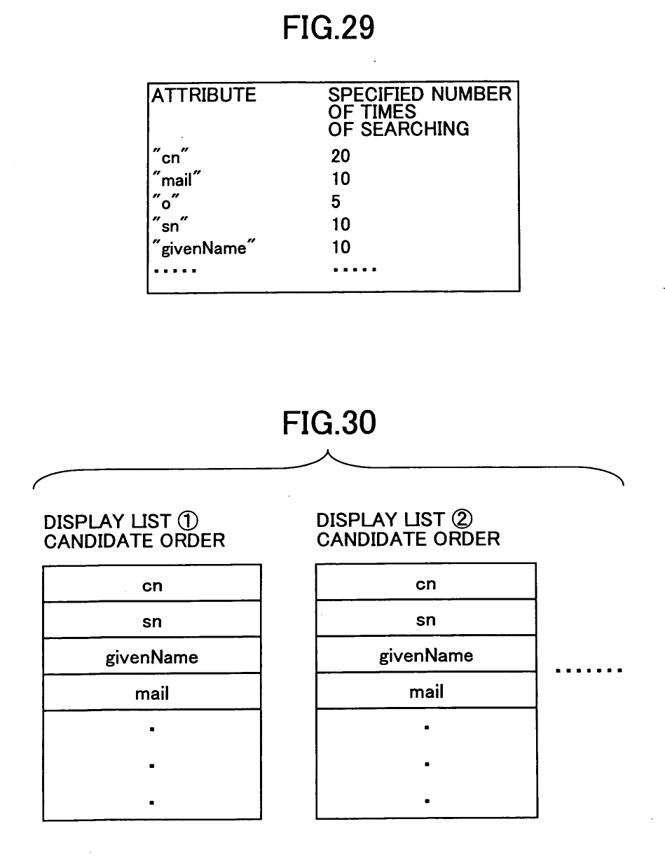

It is possible to readily determine whether the extracted attribute is often specified as a search item by, for example, recording for each attribute the number of times (specified number of times of searching) the attribute is specified as a search item. FIG. 29 is a diagram showing an exemplary image of a table for recording the specified number of times of searching for each attribute.

In addition, in step S804, extracted attributes may be divided into the LDAP search result list screen and the LDAP search result detailed screen depending on an application that issues a search request. Further, in step S804, those attributes having a large number of hits among attributes specified as search items may be allocated in the LDAP search result list screen, and the other attributes may be allocated to the LDAP search result detailed screen.

Additionally, the UCS 37 may include several candidate attributes for each display layout item, and vary the display layout of the LDAP search result screen in accordance with obtained attributes. FIG. 30 is a diagram showing exemplary candidate attributes for each display layout item.

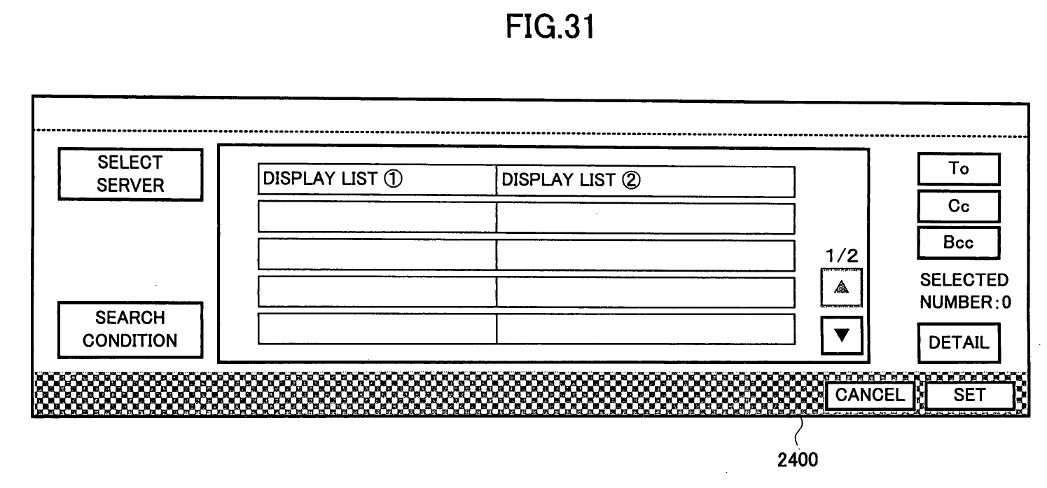

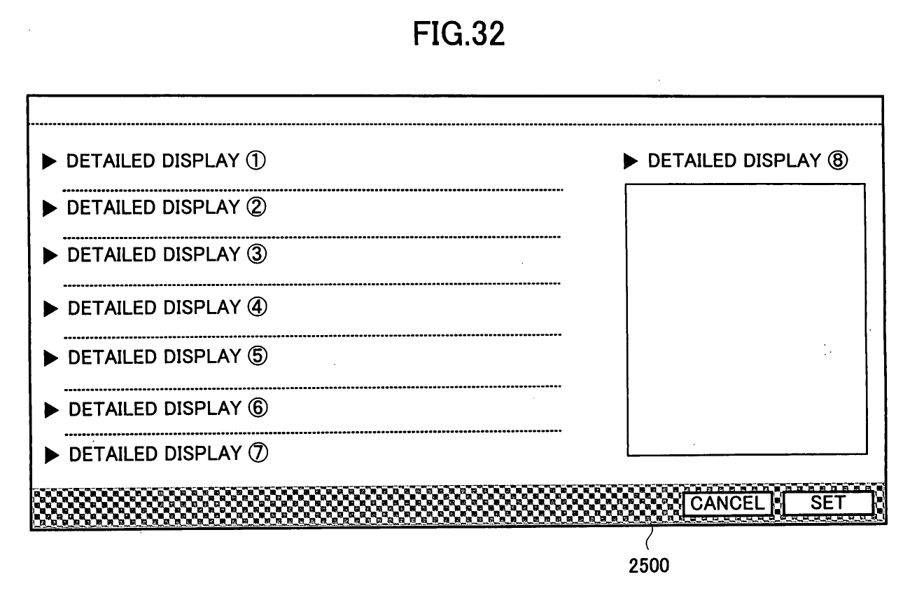

As shown in FIG. 30, the UCS 37 may include candidate attributes for each display layout item, such as “display list \mathring{1}”. Display layout items correspond to, for example, fields of “display list \mathring{1}” and “display list \mathring{2}” in a display layout setting screen 2400 shown in FIG. 31, and fields of “detailed display \mathring{1}” through “detailed display \mathring{6}” in a display layout setting screen 2500 shown in FIG. 32.

The UCS 37 may obtain all attributes included in the candidate attributes for each display layout item, and allocate a candidate attribute having a high priority to a corresponding field of the display layout item. The order of obtaining candidate attributes may be, for example, “display list \mathring{1}”, “display list \mathring{2}”, and “detailed display \mathring{1}” through “detailed display \mathring{6}”.

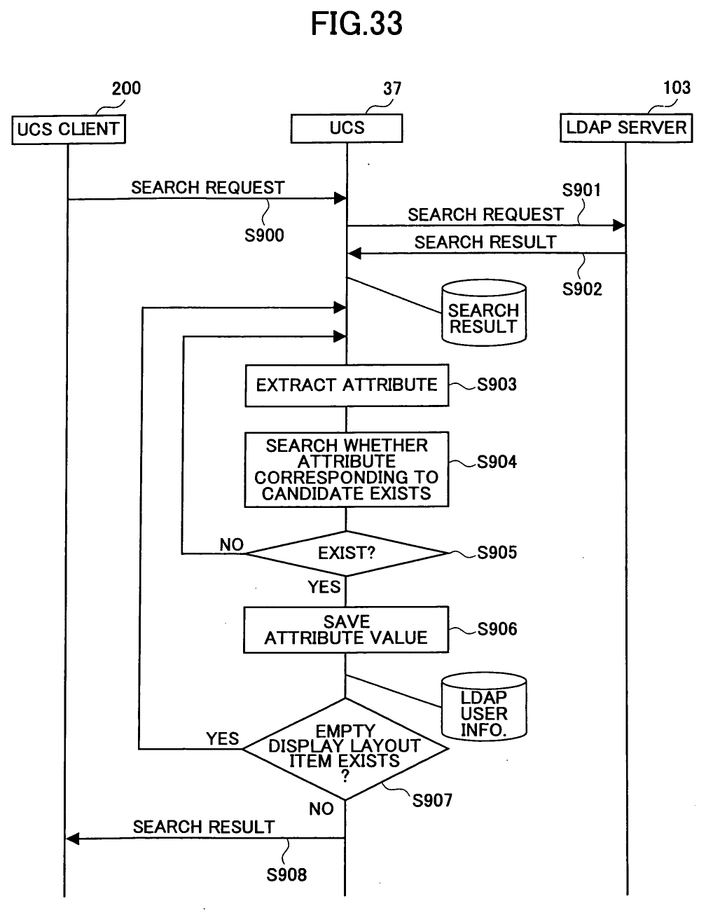

Referring to a sequence diagram shown in FIG. 33, a description is given of a process in the case where the UCS 37 includes several candidate attributes for each display layout item, and the display layout of the LDAP search result screen is modified in accordance with obtained attributes. FIG. 33 is the sequence diagram showing another example of the LDAP search.

In step S900, the UCS client 200 issues a LDAP search request to the UCS 37. When issuing the LDAP search request to the UCS 37, the UCS client 200 supplies, to the UCS 37, search target LDAP server information and search information, together with the LDAP search request.

In step S901, the UCS 37 issues one or more search requests corresponding to the search information to one or more of the LDAP servers 103 that are specified in the search target LDAP server information supplied from the UCS client 200. In step S902, the UCS 37 receives the search result corresponding to the search request in step S901. The search result received in step S901 is, for example, information of all attributes in the candidate attributes for each entry.

In step S903, the UCS 37 extracts an attribute from the search result. In step S904, the UCS 37 searches the candidate attributes for the attribute extracted in step S903 (determines whether the extracted attribute corresponds to any one of the candidate attributes). In step S905, if there is a candidate attribute corresponding to the extracted attribute (YES in step S905), the process proceeds to step S906. On the other hand,.when there is no candidate attribute corresponding to the extracted attribute (NO in step S905), the process returns to step S903. In step S906, the UCS 37 saves the attribute value of the attribute corresponding to the candidate attribute. That is, display configuration information (display layout information) is added to the LDAP user information as a modification of the values of attributes (attribute values), such as a name and a mail address, as shown in FIG. 26.

In step S907, the UCS 37 determines whether there is an empty display layout item. When it is determined that there is an empty layout item (YES in step S907), the process returns to step S903.

On the other hand, when it is determined that there is no empty layout item (NO in step S907), the process proceeds to step S908, where the LDAP user information is supplied to the UCS client 200 as the response to the LDAP search request in step S900. Based on the response supplied in step S908 to the LDAP search request, the UCS client 200 displays, on the operational panel 80, the LDAP search result detailed screen as shown in FIG. 27.

Accordingly, it is possible for the UCS 37 to modify the display configuration of the LDAP search result screen in accordance with obtained attributes by including several candidate attributes for each display layout item.

The present invention is not limited to the specifically disclosed embodiments, and variations and modifications may be made without departing from the scope of the present invention.

The present application is based on Japanese Priority Application No. 2004-003120 filed on Jan. 8, 2004, the entire contents of which are hereby incorporated by reference.

1. An information processing apparatus capable of searching an information storing server located outside for data formed with one or more attributes,
wherein data types of the attributes can be set and, when setting an attribute to be obtained from the information storing server as an obtaining attribute, a corresponding one of the data types of each of the attributes can be presented to a user.

2. The information processing apparatus as claimed in claim 1, comprising a function of causing the user to set one of the data types to each of the attributes when setting the attributes.

3. The information processing apparatus as claimed in claim 1, comprising a function of performing pre-search of the attributes and, in accordance with the attribute obtained from the information storing server as a search result, determining and setting the data type of the attribute.

4. The information processing apparatus as claimed in claim 3, wherein, when a predetermine control character is included in the attribute obtained from the information storing server, the data type of the attribute is determined to be binary data.

5. The information processing apparatus as claimed in claim 3, wherein, when a description representing binary data is included in a header part of the attribute obtained from the information storing server, the data type of the attribute is determined to be binary data.

6. The information processing apparatus as claimed in claim 3, wherein the attributes obtained from the information storing server are displayed on an operational panel, and the user is caused to set the data type for each of the attributes.

7. The information processing apparatus as claimed in claim 1, wherein relationships between one or more of the attributes that are likely to be set by the user and the data types of the attributes are registered in advance, and the information processing apparatus includes a function of determining and setting the data types of the attributes by using the registered relationships.

8. The information processing apparatus as claimed in claim 1, wherein relationships between the attributes and the data types previously set as the data types of the attributes are registered, and the information processing apparatus includes a function of determining and setting the data types of the attributes by using the registered relationships.

9. The information processing apparatus as claimed in claim 1, comprising a function of modifying an order of obtaining the attributes from the information storing server as a result of searching for the attributes in accordance with the data types of the attributes.

10. The information processing apparatus as claimed in claim 9, wherein, among the attributes, one of the attributes having a predetermined data type is obtained first, and thereafter the attributes having the data types other than the predetermined data type are obtained.

11. The information processing apparatus as claimed in claim 9, wherein, among the attributes, one of the attributes having a predetermined data type is obtained first, and thereafter the attributes having the data types other than the predetermined data type are obtained upon an obtaining request for the attributes having the data types other than the predetermined data type.

12. The information processing apparatus as claimed in claim 1, wherein, when searching for the attributes, the user is caused to set an order for obtaining the attributes from the information storing server as a search result.

13. The information processing apparatus as claimed in claim 1, comprising a function of displaying the attributes obtained from the information storing server on an operational panel based on a display layout.

14. The information processing apparatus as claimed in claim 13, wherein the display layout is displayed on a display panel, and the user is caused to set the display layout.

15. The information processing apparatus as claimed in claim 13, wherein the display layout is set in accordance with one or more of the attributes input as search conditions.

16. The information processing apparatus as claimed in claim 13, wherein the display layout is set in accordance with one or more of the attributes frequently input as search conditions.

17. The information processing apparatus as claimed in claim 13, wherein the display layout is set in accordance with an application that issues a search request.

18. The information processing apparatus as claimed in claim 13, wherein the display layout is set in accordance with one or more of the attributes having a large number of hits based on a result of the search.

19. A data search method for an information processing apparatus capable of searching an information storing server located outside for data formed with one or more attributes, said data search method comprising the steps of:
presenting data types of the attributes to a user; and
causing the user to set one or more of the attributes to be obtained from the information storing server as an obtaining attribute.

20. A data search program for causing a computer to search an information storing server located outside for data formed with one or more attributes, said data search program comprising the instructions of:
presenting data types of the attributes to a user; and
causing the user to set one or more of the attributes to be obtained from the information storing server as an obtaining attribute.
